(19) United States
(12) Patent Application Publication
(10) Pub. No.: US 2009/0172122 A1
(43) Pub. Date: Jul. 2, 2009

(54) Message Transmission Method, Message Transmission Device, and Storage Medium Recorded with Message Transmission Program

(75) Inventors: Naotsugu Toume, Yokohama (JP); Koichi Shimazaki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/336,616

(22) Filed: Dec. 17, 2008

(30) Foreign Application Priority Data
Dec. 27, 2007 (JP) 2007-337276

(51) Int. Cl. G06F 15/16

(52) U.S. Cl. 709/206

(57) ABSTRACT

Provided is a method of transmitting a message in a business process management system that includes a service execution device providing services and a business process management device. The business process management device executes a business process defined by combining the services, the business process includes a definition of the message transmitted to the service execution device, the business process management system includes preceding transmission part management information that includes a preceding transmission part which is a part or an entirety of the message that can be divided and transmitted and information for identifying a processing in which contents of the preceding transmission part can be determined, and after the processing in which the contents of the preceding transmission part can be determined has been executed, according to the preceding transmission part management information, before the service is called, the preceding transmission part is transmitted to the service execution device.

### CLAIM OF PRIORITY

The present application claims priority from Japanese application JP2007-337276 filed on Dec. 27, 2007, the content of which is hereby incorporated by reference into this application.

### BACKGROUND OF THE INVENTION

This invention relates to a technique for reducing an execution time for a business process, in particular, a technique for transmitting a message to a service.

As a system under development in recent years, there is widely known a business process management system for quickly building a new service called “business process” by combining services that have been already provided by a system in order to deal speedily with changes in business. For example, JP 2007-4414 A discloses a technique for sorting requests (messages) toward a plurality of business processes as an invention related to the business process management system.

The service herein represents a program that is stored in a main memory of a computer and executed by a CPU thereof. The service creates a response message based on a transmission message received from a client, and returns the created response message to the client. To transmit a transmission message to a service is referred to as a “service call”. It should be noted that the client also represents a program that is stored in a main memory of a computer and executed by a CPU thereof.

In the same manner as the service, the business process represents a program that is stored in a main memory of a computer and executed by a CPU thereof. The business process receives a transmission message transmitted from a client, calls a service based on a business process definition, creates a response message by using a response message received from the service or the like, and returns the response message to the client.

As a typical business process definition language for describing such a business process described above, Business Process Execution Language for Web Services (BPEL) is known. Further, as a typical language for defining an interface of a service such as a structure of a message transmitted to/received from the service, Web Services Description Language (WSDL) is known.

In addition, as a typical network protocol for a service and a message to be transmitted/received, Simple Object Access Protocol (SOAP) is known. For example, use of SOAP as the network protocol for a service or the like is described in a service interface definition by WSDL.

SOAP is the network protocol based on character-based XML, and hence binary data contained in a transmission message is converted into a character string formed of alphanumeric characters by using a scheme called base64 or the like. However, the character string after the conversion becomes larger in size than the source binary data, and hence a communication efficiency becomes worse if handling a message containing binary data larger in size. Therefore, SOAP Messages with Attachments (SwA) and SOAP Message Transmission Optimization Mechanism (MTOM) are known as a technique for improving the communication efficiency.

SwA and MTOM use MIME that defines a message structure for communicating various kinds of data. The message structure defined by MIME is formed of data divided into a plurality of items by a special delimiter character string called “MIME boundary” and a MIME header in which control information related to the MIME boundary and kinds of data is described. In addition, parts corresponding to individual data items obtained by the dividing by the MIME boundary are referred to as “MIME parts”.

In SwA and MTOM, a transmission message is divided into a character-based XML part and a binary data part, which are stored in mutually different MIME parts, and the binary data is transmitted as it is without being converted into a character string. A receiving end consolidates the data stored in the different MIME parts to restore the original transmission message. This allows efficient transmission of the binary data part.

### SUMMARY OF THE INVENTION

In the business process management system, if a size of data contained in a message to be transmitted to the service becomes larger, a time period necessary to transmit the message is more likely to become a bottleneck. Further, in the business process which calls a plurality of services in order, processing time periods for the called services and waiting time periods until response messages are received from the services are included in a time period required for the entire business process.

On the other hand, in the business process management system, by executing the service call in parallel, it is possible to transmit a message to another service in parallel with waiting for a response from the called service. Accordingly, by thus executing the services in parallel, the time period required for the entire business process can be reduced.

However, in order to execute the services in parallel, the business process definition or the service cannot be changed in some cases even if there is a need for a change thereof. For example, the change of the business process may be impossible for the following reasons.

(1) There is a dependency in terms of processing between the services, and the service call cannot be executed in parallel without changing the service.

(2) The business process or the service is strongly related to contents of a task of a user, and the service call cannot be executed in parallel for a task-related reason.

(3) To speedily change the business process definition according to a change of the task of the user, a process flow of the business process is set to have the same manner as a flow of the task, and a process flow of the business process definition is also set to be easy to change according to a change of a task flow.

Further, the change of the service may be impossible for the following reasons.

(4) The service may be possessed by another organization, another package application, or the like.

(5) The service is also used by another business process, and hence may affect the another business process.

(6) A cost for changing the service may be high. For example, in the service implemented by an old system, there may exist no engineer that can change the service.

For the above-mentioned reasons, it is often difficult to change the business process definition or the service. Therefore, in the conventional business process management system, it is difficult to reduce the time period required for the entire business process by executing the service call in parallel.

It is an object of this invention to provide a method and a device in which if there is a transmission message part that can be transmitted prior to a call processing step for a service described in a business process definition, the message part is transmitted prior to the service call processing step without changing the business process definition or the service.

The representative aspects of this invention are as follows. That is, there is provided a message transmission method for a business process management system comprising: a service execution device; and a business process management device connected to the service execution device, the message transmission method being used for transmitting a message from the business process management device to the service execution device, the service execution device providing predetermined services based on the message transmitted from the business process management device, the business process management device comprising: a processor; a storage section that can be accessed by the processor; and an interface connected to the service execution device, the business process management device being configured to process a task by executing a business process defined by combining the predetermined services, the business process including: a definition of the message transmitted to the service execution device; and an order of executing processings of calling the predetermined services, the business process management system including preceding transmission part management information that includes: a preceding transmission part which is one of a part and an entirety of the message that can be divided and transmitted before one of the predetermined services is called; and information for identifying a processing in which contents of the preceding transmission part can be determined the message transmission method comprising: judging whether or not the processing in which the contents of the preceding transmission part can be determined is performed, based on the preceding transmission part management information; and transmitting, after the processing in which the contents of the preceding transmission part can be determined has been executed, before a service to which a message including the preceding transmission part is to be transmitted is called, the preceding transmission part to the service execution device providing the service.

According to an embodiment of this invention, a part or an entirety of the message for calling the service is precedingly transmitted to the service execution device prior to the service call processing step without changing the business process definition or the service to thereby allow reduction of the time period required for the entire business process.

### BRIEF DESCRIPTION OF THE DRAWINGS

The present invention can be appreciated by the description which follows in conjunction with the following figures, wherein:

FIG. 1 is a system configuration diagram of a business process management system according to a first embodiment of this invention;

FIG. 2 is a diagram illustrating a configuration including hardware of the business process management system according to the first embodiment of this invention;

FIG. 3 is a diagram illustrating an example of a business process according to the first embodiment of this invention;

FIG. 4 is a diagram illustrating a description example of a business process definition showing an example of the business process according to the first embodiment of this invention;

FIG. 5 is a diagram illustrating an example where an interface for calling a service is described in WSDL in the example of the business process according to the first embodiment of this invention;

FIG. 6A is a diagram illustrating an example of a preceding transmission part management table according to the first embodiment of this invention;

FIG. 6B is a diagram illustrating an example of a preceding transmission status management table according to the first embodiment of this invention;

FIG. 6C is a diagram illustrating an example of a business process variable value management table according to the first embodiment of this invention;

FIG. 7A is a diagram illustrating an example of a business process definition according to the first embodiment of this invention;

FIG. 7B is a diagram illustrating an example of a business process execution status management information according to the first embodiment of this invention;

FIG. 7C is a diagram illustrating an example of a service interface definition according to the first embodiment of this invention;

FIG. 8 is a flowchart illustrating a procedure of processing performed by a preceding transmission part finding module according to the first embodiment of this invention;

FIG. 9 is a flowchart illustrating a procedure of preceding transmission processing according to the first embodiment of this invention;

FIG. 10 is a flowchart illustrating a procedure of a service call part of the preceding transmission processing according to the first embodiment of this invention;

FIG. 11 is a flowchart illustrating a procedure of a communication part of the preceding transmission processing according to the first embodiment of this invention;

FIG. 12 is a diagram illustrating the business process for an online auction listing task to which the first embodiment of this invention is applied;

FIG. 13 is a diagram illustrating a flow of a processing in the case where the first embodiment of this invention is applied to the online auction listing task;

FIG. 14 is a diagram illustrating an example of the flow of the processing in a case where conventional technique is applied to the online auction listing task according to the first embodiment of this invention;

FIG. 15 is a diagram illustrating an example of the message transmitted to an item information publication service according to the first embodiment of this invention;

FIG. 16 is a system configuration diagram of a business process management system according to a second embodiment of this invention;

FIG. 17 is a system configuration diagram of a business process management system according to a third embodiment of this invention;

FIG. 18A is a flowchart illustrating a procedure of a communication part of the preceding transmission processing according to the third embodiment of this invention;

FIG. 18B is a flowchart illustrating a procedure of a communication part of the preceding transmission processing according to the third embodiment of this invention;

FIG. 19 is a system configuration diagram of a business process management system according to a fourth embodiment of this invention; and

FIG. 20 is a diagram illustrating a configuration of a shared DB according to the fourth embodiment of this invention.

### DETAILED DESCRIPTION OF THE PREFERRED EMBODIMENTS

Hereinafter, description is made of embodiments of this invention by referring to the accompanying drawings.

### First Embodiment

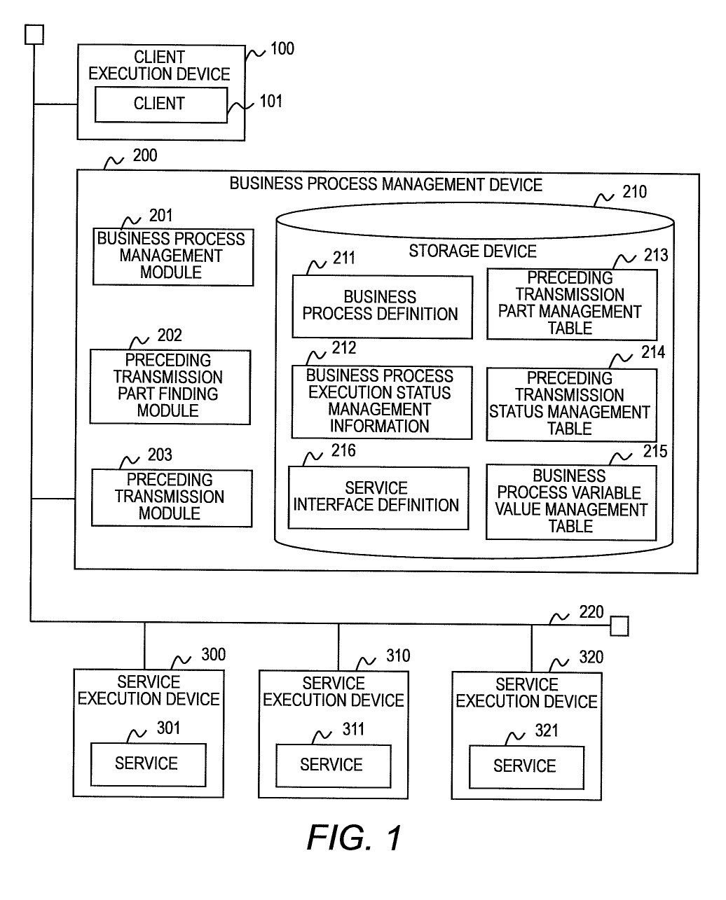

FIG. 1 is a system configuration diagram of a business process management system according to a first embodiment of this invention.

The business process management system according to the first embodiment of this invention includes a business process management device 200, a client execution device 100, and service execution devices (300, 310, and 320). The business process management device 200, the client execution device 100, and the service execution devices (300, 310, and 320) are connected to one another via a network 220.

The client execution device 100 represents a device for using a business process. The client execution device 100 includes a client 101 that exchanges a message with the business process management device 200.

The client 101 represents a program executed for carrying out a task processing by using the business process. The client execution device 100 executes the client 101 to thereby communicate with the business process management device 200 via the network 220.

The business process management device 200 represents a device for managing the business process. The business process management device 200 includes a business process management module 201, a preceding transmission part finding module 202, a preceding transmission module 203, and a storage device 210.

The storage device 210 stores a business process definition 211, business process execution status management information 212, a preceding transmission part management table 213, a preceding transmission status management table 214, a business process variable value management table 215, and a service interface definition 216.

Information related to a business process definition described in BPEL or the like is stored in the business process definition 211.

Information for managing an execution status of the business process is stored in the business process execution status management information 212. The information for managing the execution status of the business process includes information such as an identifier of a currently-running business process, a processing step that is currently being processed by the business process, and a value of a variable used for storing a message transmitted/received by the business process.

The business process management module 201 manages execution of the processing step of the business process and the execution status of the business process based on the business process definition 211 and the business process execution status management information 212.

The service execution device 300 provides a service 301 that executes a process requested by the business process management device 200. The service execution device 300 communicates with the business process management device 200 via the network 220. In the same manner, the service execution device 310 provides a service 311, and the service execution device 320 provides a service 321.

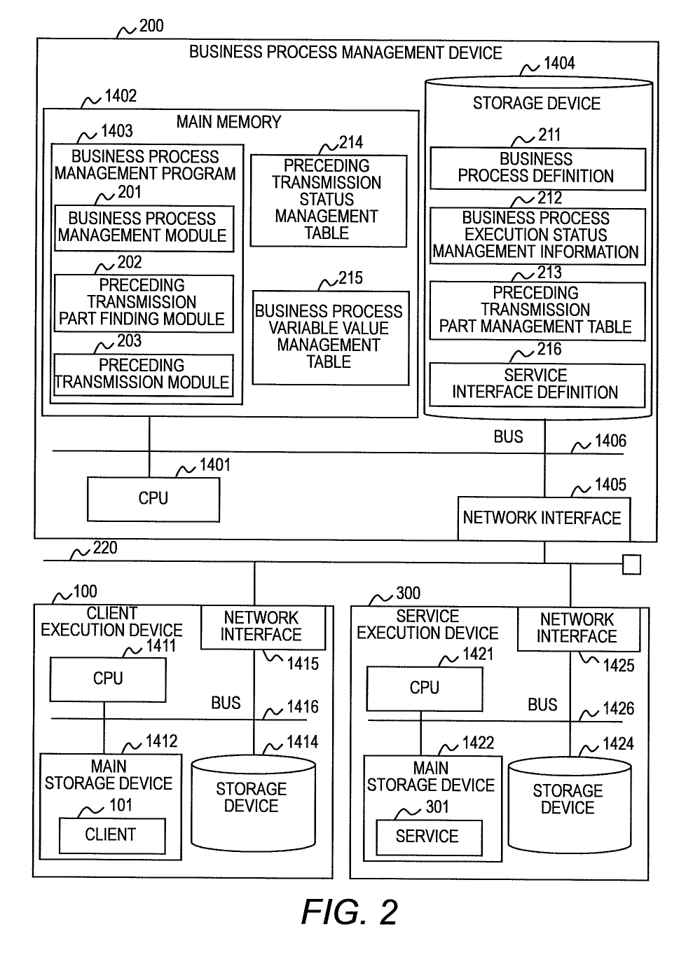

FIG. 2 is a diagram illustrating a configuration including hardware of the business process management system according to the first embodiment of this invention.

As described above, the business process management system includes the business process management device 200, the client execution device 100, and the service execution device 300.

The business process management device 200 includes a CPU 1401, a main memory 1402, a storage device 1404, and a network interface 1405. The CPU 1401, the main memory 1402, the storage device 1404, and the network interface 1405 are connected to one another via a bus 1406.

The main memory 1402 stores a business process management program 1403 executed by the CPU 1401. The business process management program 1403 includes the business process management module 201, the preceding transmission part finding module 202, and the preceding transmission module 203.

In addition, the main memory 1402 stores the preceding transmission status management table 214 and the business process variable value management table 215. The preceding transmission status management table 214 and the business process variable value management table 215 may be stored in the storage device 1404.

The storage device 1404 includes the business process definition 211, the business process execution status management information 212, the preceding transmission part management table 213, and the service interface definition 216. The business process definition 211, the business process execution status management information 212, the preceding transmission part management table 213, and the service interface definition 216 may be stored in the main memory 1402.

The network interface 1405 is connected to the network 220.

The client execution device 100 includes a CPU 1411, a main memory 1412, a storage device 1414, and a network interface 1415. The CPU 1411, the main memory 1412, the storage device 1414, and the network interface 1415 are connected to one another via a bus 1416.

The main memory 1412 stores the client 101 executed by the CPU 1411. The network interface 1415 is connected to the network 220.

The service execution device 300 includes a CPU 1421, a main memory 1422, a storage device 1424, and a network interface 1425. The CPU 1421, the main memory 1422, the storage device 1424, and the network interface 1425 are connected to one another via a bus 1426.

The main memory 1422 stores the service 301 executed by the CPU 1421. The network interface 1425 is connected to the network 220.

Herein, the first embodiment of this invention is described by illustrating a specific example of the business process.

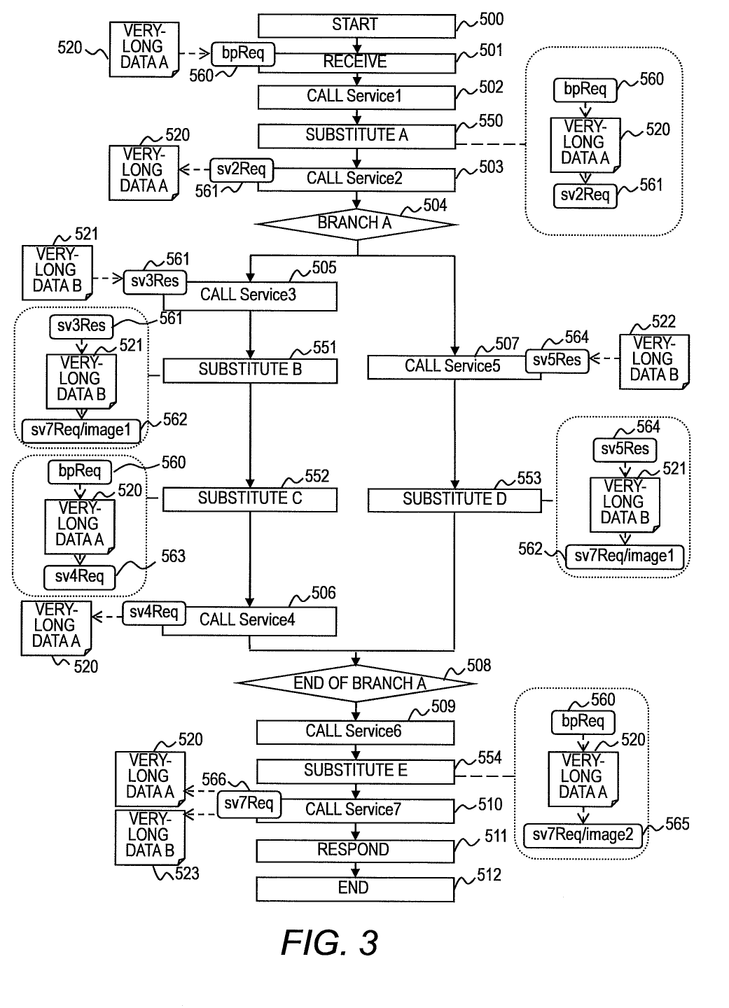

FIG. 3 is a diagram illustrating an example of the business process according to the first embodiment of this invention.

As described above, the business process carries out a task by executing combined services that are created in advance.

Step 500 “START” indicates the start of a business process. Step 501 “RECEIVE” represents a processing step of receiving a message from the client and starting the business process. Very-long data A 520 indicates that large-size data is contained in the message received from the client. The received message that contains the very-long data A 520 is stored into a variable bpReq 560.

Step 502 “CALL Service 1” represents a processing step of calling Service 1. Herein, “Service 1” refers to a service named “Service 1”. Hereinafter, the same holds true for “Service2” through “Service7”.

In Step 550 “SUBSTITUTE A”, the very-long data A 520 contained in the variable bpReq 560 is substituted into a variable sv2Req 561.

Step 503 “CALL Service2” represents a processing step of calling Service2. Further, a message transmitted to Service2 contains the very-long data A 520 received in Step 501 “RECEIVE” and substituted into the variable sv2Req 561 in Step 550 “SUBSTITUTE A”.

Step 504 “BRANCH A” represents a branch at which Step 505 “CALL Service3” or Step 507 “CALL Service5” is executed according to conditions.

Step 505 “CALL Service3” represents a processing step of calling Service3, and a message received from Service3 contains very-long data B 521. The received message that contains the very-long data B 521 is stored into a variable sv3Res 561. In Step 551 “SUBSTITUTE B”, the very-long data B 521 contained in the variable sv3Res 561 is stored into a message part “image1” of a variable sv7Req (562 of FIG. 3). In Step 552 “SUBSTITUTE C”, the very-long data A 520 contained in the variable bpReq 560 is stored into a variable sv4Req 563. Step 506 “CALL Service4” represents a processing step of calling Service4, and a message transmitted to Service4 contains the very-long data A 520 contained in the variable sv4Req 563.

Step 507 “CALL Service5” represents a processing step of calling Service5, and a message received from Service5 contains very-long data B 522. The received message that contains the very-long data B 522 is stored into a variable sv5Res 564. In Step 553 “SUBSTITUTE D”, the very-long data B 522 contained in the variable sv5Res 564 is stored into the message part “image1” of the variable sv7Req (562 of FIG. 3).

Step 508 “END OF BRANCH A” indicates the end of the branch started in Step 504 “BRANCH A”.

Step 509 “CALL Service6” represents a processing step of calling Service6. In Step 554 “SUBSTITUTE E”, the very-long data A 520 contained in the variable bpReq 560 is stored into a message part “image2” of the variable sv7Req (565 of FIG. 3). Step 510 “CALL Service7” represents a processing step of calling Service7. In Step 510 “CALL Service7”, a message transmitted to Service7 contains the very-long data A 520 and very-long data B 523 that are contained in a variable sv7Req 566. Contents of the very-long data B 523 differ depending on a branch destination in Step 504 “BRANCH A” between contents of the very-long data B 521 received in Step 505 “CALL Service3” and contents of the very-long data B 522 received in Step 507 “CALL Service5”.

Step 511 “RESPOND” represents a processing step of transmitting a response message to the client and bringing the business process to an end. Step 512 “END” indicates the end of the business process.

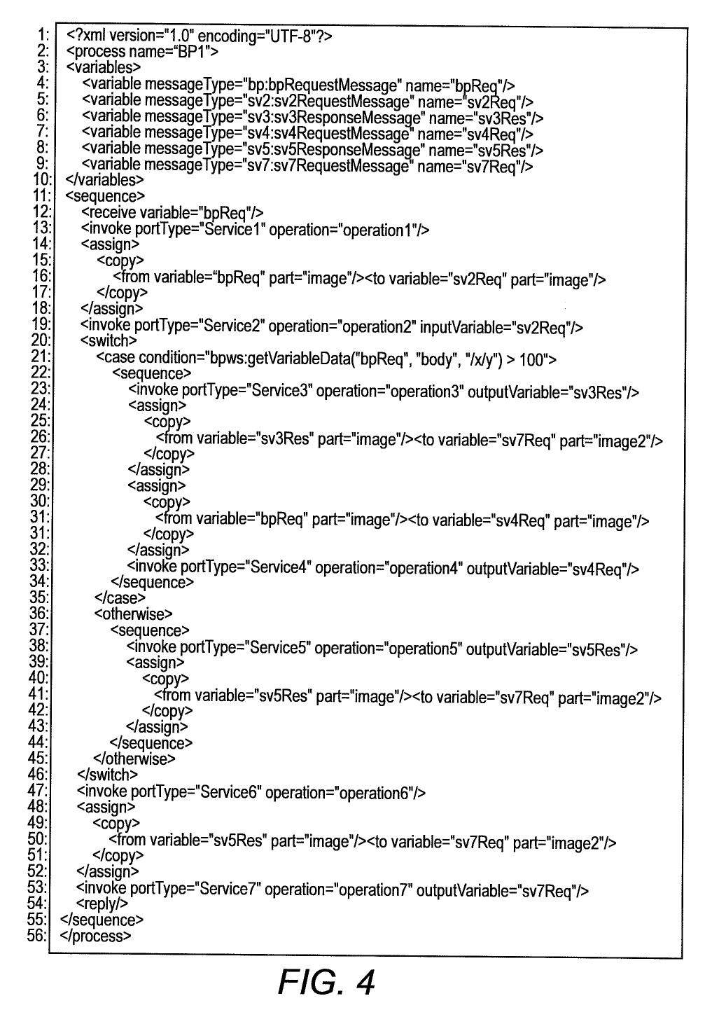

FIG. 4 is a diagram illustrating a description example of the business process definition 211 showing an example of the business process according to the first embodiment of this invention.

The business process definition 211 is described in BPEL and stored in the storage device 1404. BPEL defines an activity that regulates a basic processing. Declaration of variables that store messages to be transmitted/received when the services are called, description of activities of calling the services, specification of variables that store messages transmitted when the services are called, specification of variables that store messages received when the services are called, and the like can be described in BPEL.

To briefly explain a correspondence between FIG. 3 and FIG. 4, the business process is started by <receive variable=“bpReq”/> in line 12, which corresponds to Step 501 “RECEIVE”. The execution of the service is described as an “invoke” activity, and the description corresponding to Step 502 “CALL Service1” is <invoke portType=“Service” operation=“operation1”/> in line 13.

The data contained in the transmitted/received message is specified by a variable described in each activity. For example, in the invoke activity in line 19, the description of “inputVariable=“sv2Req”” indicates that a message contained in the variable “sv2Req” is transmitted. Further, in the invoke activity in line 23, the description of “outputVariable=“sv3Res”” indicates that the message received from the service is stored into the variable “sv3Res”.

In addition, names and types of variables that store messages are specified by the declaration of variables. For example, the declaration of variables is described in lines 3 through 10, <variable messageType=“bp:bpRequestMessage” name=“bpReq”/> in line 4 declares a variable whose name is “bpReq” and whose type is “bp:bpRequestMessage”. It should be noted that the type “bp:bpRequestMessage” is defined in detail in the service interface definition 216.

The received data is substituted by an “assign” activity into another variable, which is transmitted to another service or transmitted to the client. Specifically, the message received in Step 501 “RECEIVE” is stored in the variable “bpReq”, but a part thereof, namely, the message part “image”, is substituted into the message part “image” of the variable “sv2Req” by the processing in lines 14 through 18.

It should be noted that a message part other than the message part “image” of “sv2Req” may be subjected to a processing of substituting some value. The description of such a substitution processing is partially omitted from the description in BPEL of FIG. 4, which indicates only the substitution processing for a message part related to very-long data.

Then, in line 19, Step 503 “CALL Service2” is executed, and “sv2Req” is transmitted to the service execution device 300 that executes Service2.

In addition, the branch is described by a “switch” activity. In FIG. 4, Step 504 “BRANCH A” is described in line 20, and the end of the branch is described in line 46. Finally, “reply” is used to transmit processing results to the client. In FIG. 4, “reply” corresponds to <reply/>in line 54.

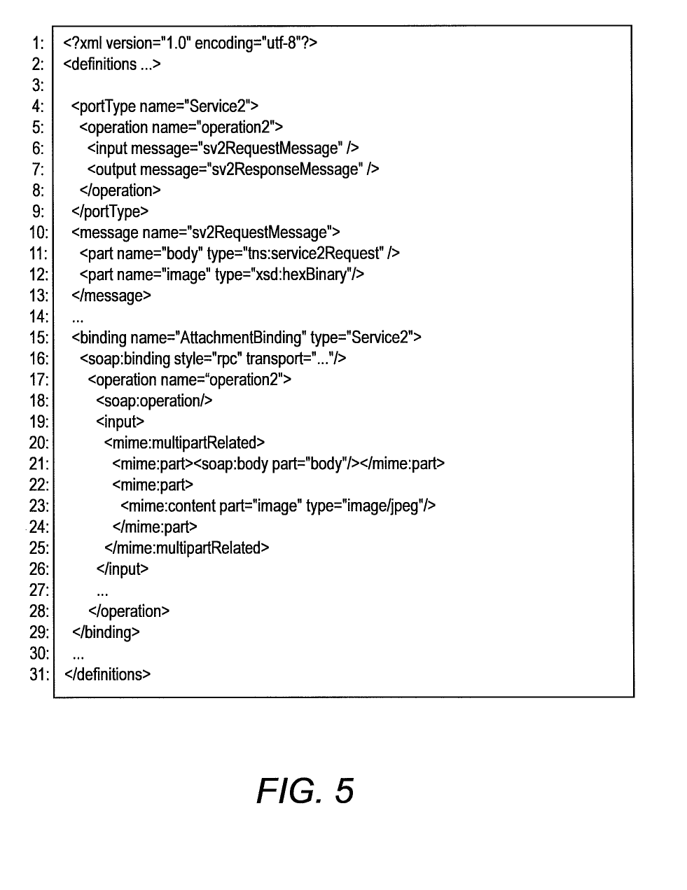

FIG. 5 is a diagram illustrating an example where an interface for calling a service is described in WSDL in the example of the business process according to the first embodiment of this invention.

The service interface definition 216 is described in WSDL as illustrated in FIG. 5, and stored in the storage device 1404.

FIG. 5 illustrates an example where an interface definition of Service2 called by the business process illustrated in FIG. 3 is described in WSDL.

Lines 4 through 9 indicate the interface of the service Service2, and line 6 indicates that the message sv2RequestMessage is received.

Further, lines 10 through 13 indicate a structure of the message sv2RequestMessage. The lines indicate that the message is structured of the message part “body” (line 11) and the message part “image” (line 12). Line 12 indicates that the “type” of the message part “image” is “xsd:hexBinary”, namely, binary data.

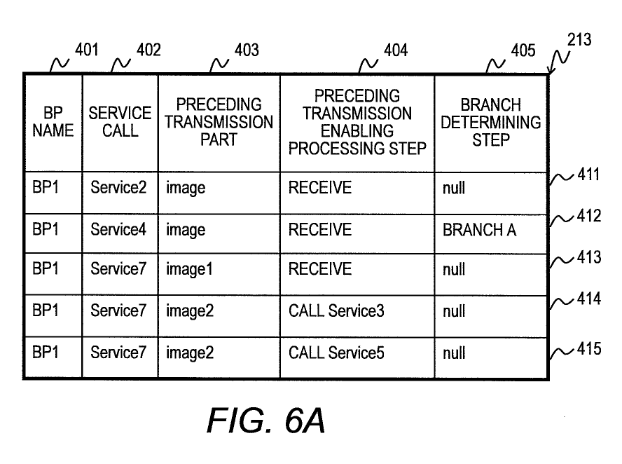

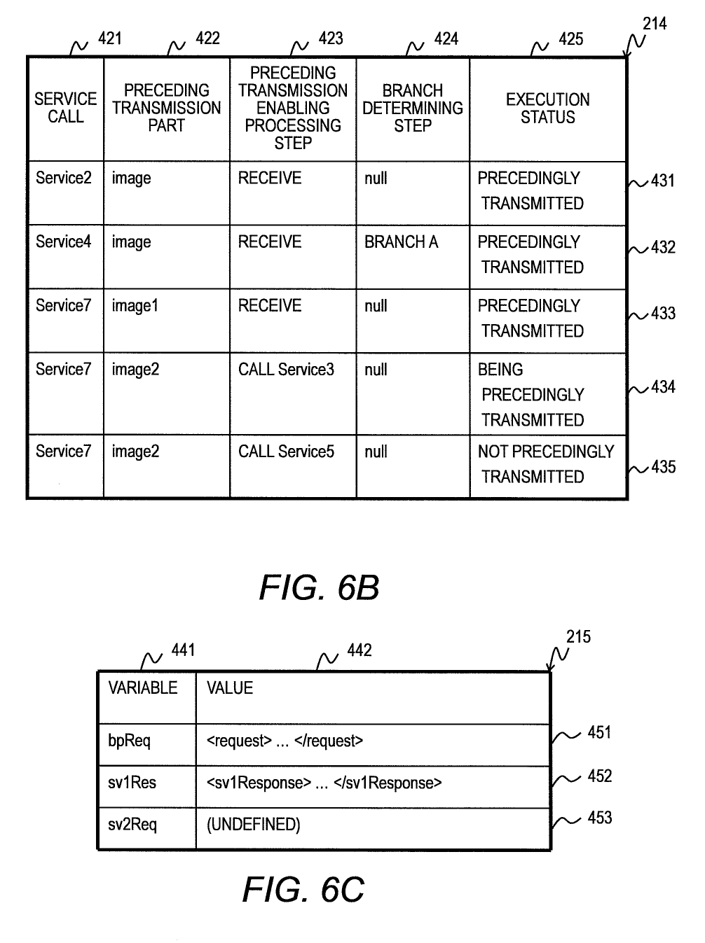

FIG. 6A is a diagram illustrating an example of the preceding transmission part management table 213 according to the first embodiment of this invention.

The preceding transmission part management table 213 represents a table for holding information related to a preceding transmission part. The preceding transmission part management table 213 includes a business process (BP) name 401, a service call 402, a preceding transmission part 403, a preceding transmission enabling processing step 404, and a branch determining step 405.

The BP name 401 represents the name of a business process. The service call 402 represents a service that is called. The preceding transmission part 403 represents such a part of a message transmitted to the service that can be precedingly transmitted.

The preceding transmission enabling processing step 404 represents a processing step in which the message part that can be precedingly transmitted becomes able to be transmitted. In other words, the preceding transmission enabling processing step 404 represents a processing step in which contents of the preceding transmission part 403 can be decided. In short, the preceding transmission enabling processing step 404 indicates that it becomes possible, when the business process advances to this processing step, to decide the contents of the preceding transmission part 403 and to precedingly transmit the preceding transmission part 403.

The branch determining step 405 represents a branch including a processing step corresponding to the service call 402.

Specifically in the description, a line 412 of the preceding transmission part management table 213 indicates that a part of the message to be transmitted to “Service4” (data stored in the message part “image”) becomes able to be precedingly transmitted at a time of the processing of receiving the business process. Further, the line 412 indicates that the service call “Service4” is included in the branch A. It should be noted that the branch determining step set to “null” indicates that the corresponding service call is not included in the branch.

A line 414 of the preceding transmission part management table 213 indicates that a part (“image2”) of the message to be transmitted to “Service7” becomes able to be precedingly transmitted at a time of “CALL Service3”. In the same manner, a line 415 indicates that the preceding transmission is enabled at a time of “CALL Service5”. “CALL Service3” and “CALL Service5” are processings included in the branch A, and hence the preceding transmission is enabled when one of the processings is completed.

FIG. 6B is a diagram illustrating an example of the preceding transmission status management table 214 according to the first embodiment of this invention.

The preceding transmission status management table 214 represents a table used by the preceding transmission module 203 managing statuses of the preceding transmission. The preceding transmission status management table 214 includes a service call 421, a preceding transmission part 422, a preceding transmission enabling processing step 423, a branch determining step 424, and an execution status 425.

The service call 421 represents a service subjected to the preceding transmission. The preceding transmission part 422 represents the message part that can be precedingly transmitted.

The preceding transmission enabling processing step 423 represents a processing step in which the message part that can be precedingly transmitted becomes able to be transmitted. The branch determining step 424 represents a branch including a processing step in which the service stored in the service call 421 field is called. The execution status 425 represents an execution status indicating, for example, whether or not the preceding transmission has been performed to the service stored in the service call 421 field.

FIG. 6C is a diagram illustrating an example of the business process variable value management table 215 according to the first embodiment of this invention.

The business process variable value management table 215 represents a table used for managing variables contained in the message transmitted by the preceding transmission module 203. The business process variable value management table 215 includes a variable 441 and a value 442. The variable 441 represents the name of a variable. The value 442 represents a value stored in the variable. A value “(undefined)” indicating that the value of the variable has not been defined yet if no value is stored in the variable (value 442 in a line 453 of FIG. 6C) is stored as the value 442.

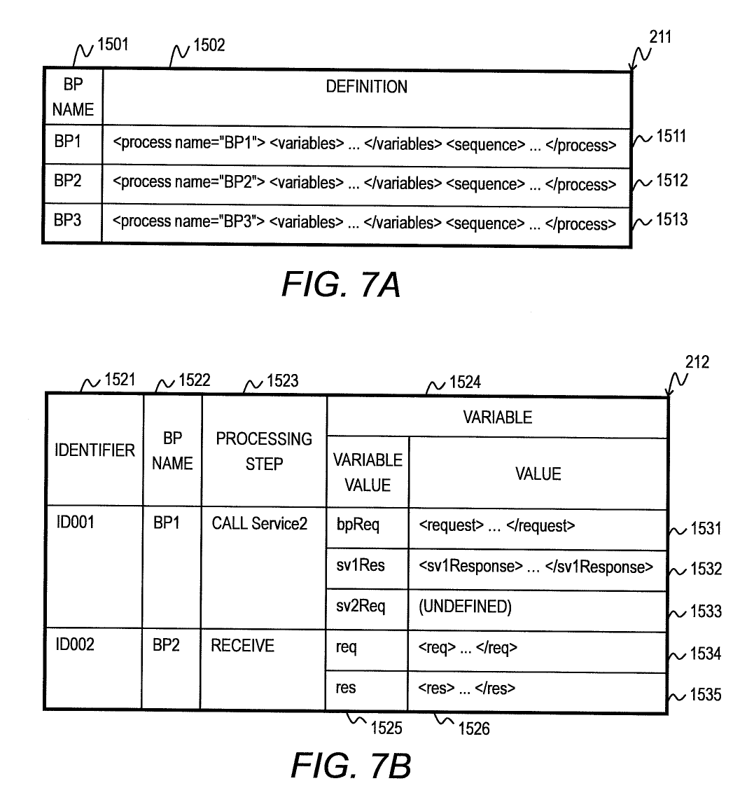

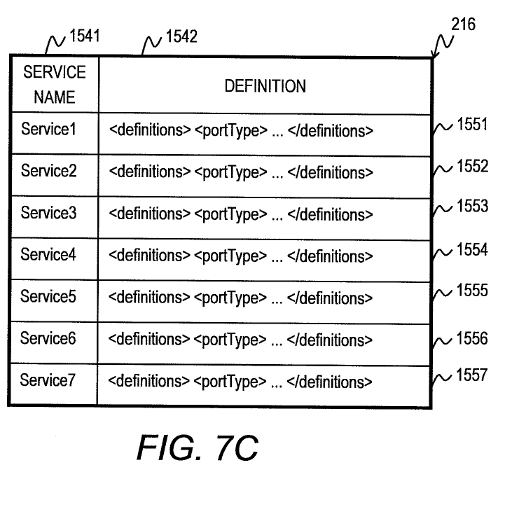

FIG. 7A is a diagram illustrating an example of the business process definition 211 according to the first embodiment of this invention.

Definitions of business processes executed by the business process management device 200 are stored in the business process definition 211. The business process definition 211 includes a BP name 1501 and a definition 1502. The BP name 1501 represents the name of a business process. The definition 1502 represents a definition of the business process described in BPEL.

Upon reception of a message from the client 101, the business process management module 201 references the definition 1502 corresponding to the requested business process. Then, based on the business process description stored as the referenced definition 1502, the service call and the like are executed while updating the business process execution status management information 212 described later.

FIG. 7B is a diagram illustrating an example of the business process execution status management information 212 according to the first embodiment of this invention.

The business process execution status management information 212 represents a table used for managing the status of the business process that is being executed by the business process management device 200. The business process execution status management information 212 includes an identifier 1521, a BP name 1522, a processing step 1523, and a variable value 1524. Further, the variable value 1524 includes a variable 1525 and a value 1526. A value “(undefined)” indicating that the value of the variable has not been defined yet if no value is stored in the variable (value 1526 in a line 1533 of FIG. 7B) is stored as the value 1526.

The identifier 1521 represents an identifier for uniquely identifying a business process. The BP name 1522 represents the name of a business process. The processing step 1523 represents a processing step that is currently being executed. The variable value 1524 represents the current status of a variable. The variable 1525 represents the name of the variable. The value 1526 represents a value stored in the variable.

Upon reception of a message from the client 101, the business process management module 201 newly adds a line to the business process execution status management information 212, and based on the business process description stored as the definition 1502 of the business process definition 211, performs the service call and updates the variable value 1524 while updating the processing step 1523.

FIG. 7C is a diagram illustrating an example of the service interface definition 216 according to the first embodiment of this invention.

The interface definition of the service that is called by the business process is stored in the service interface definition 216. The service interface definition 216 includes a service name 1541 and a definition 1542. The service name 1541 represents the name of a service. The definition 1542 represents the service interface definition described in WSDL.

The business process management module 201 uses the service interface definition described in the definition 1542 field to execute a communication processing for calling a service.

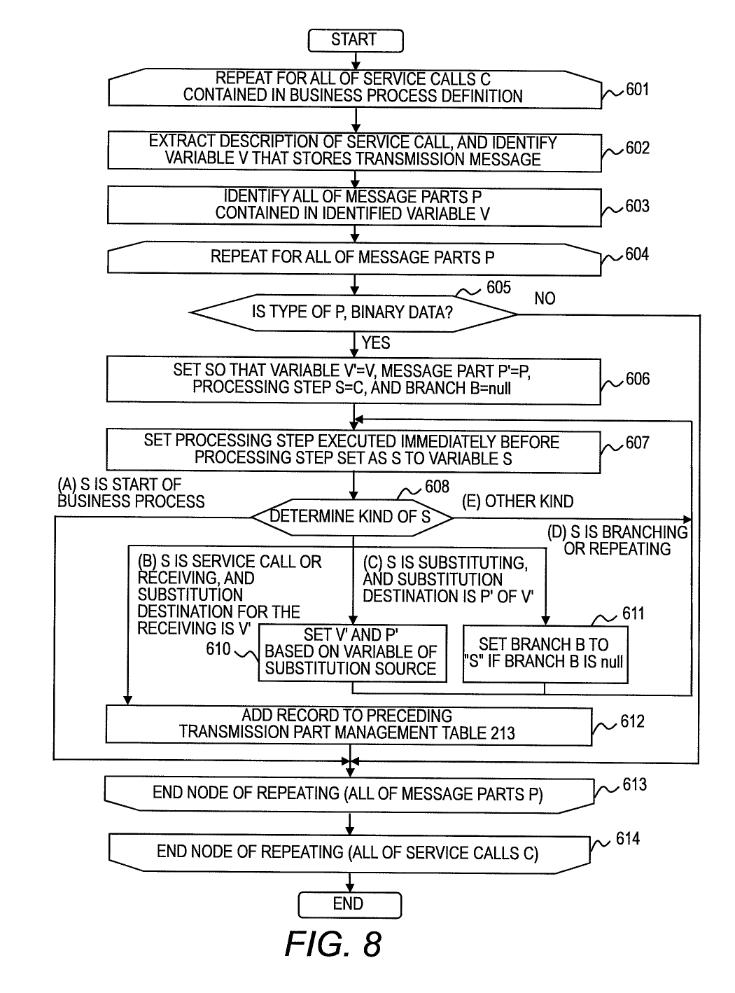

Next, FIG. 8 is used to describe a flow of a processing performed by the preceding transmission part finding module 202. The preceding transmission part finding module 202 adds a line containing information related to the preceding transmission part to the preceding transmission part management table 213 with the business process definition 211 and the service interface definition 216 used as inputs.

FIG. 8 is a flowchart illustrating a procedure of the processing performed by the preceding transmission part finding module 202 according to the first embodiment of this invention.

The CPU 1401 first references the definition (BPEL) of the business process stored as the definition 1502 of the business process definition 211 to extract all of service calls C. Then, the processing of Steps 602 through 613 is repeated for each of the extracted service calls C (Step 601). As described above, the service call C corresponds to the invoke activity in the business process definition described in BPEL. Therefore, the service call C can be extracted by extracting the description of <invoke> from the definition 1502.

The CPU 1401 extracts the description of the service call (invoke activity) from the business process definition 211, and identifies a variable V that stores a message transmitted in the service call C (Step 602). The variable V is, for example, an attribute set in “inputVariable” contained in the invoke activity.

Further, to specifically describe a case where Service2 is called in the business process illustrated in FIG. 3, Step 503 “CALL Service2” of FIG. 3 corresponds to line 19 of the business process definition illustrated in FIG. 4. By referring to the invoke activity described in line 19, the variable V turns out to be “sv2Req” from the description “inputVariable=“sv2Req””.

The CPU 1401 references a variable definition part (<variable>) of the variable V within the business process definition 211 to identify the type of the message (messsageType). Subsequently, the definition 1542 corresponding to the service to be called is acquired from the service interface definition 216. Further, a message definition part (<message>) corresponding to the type of the message is identified from the service interface definition (WSDL) described in the acquired definition 1542 field. Finally, the CPU 1401 references a message part (<part>) contained in the identified message definition to identify all of message parts P of the message to be transmitted (Step 603).

For example, in a case where the variable V is “sv2Req”, the message type of “sv2Req” is described in line 5 of the business process definition illustrated in FIG. 4, which indicates that the message type is “sv2:sv2RequestMessage”.

Further, by referring to the interface definition of Service2 illustrated in FIG. 5, the message type “sv2RequestMessage” is defined in line 10, and “body” and “image” can be identified as the message parts P.

Subsequently, the CPU 1401 repeats the processing of Steps 605 through 612 for all of the message parts P (Step 604).

The CPU 1401 references the service interface definition 216 (WSDL), and judges whether or not the “type” of the message part P is binary data (“xsd:hexBinary” or “xsd:base64Binary”) (Step 605). In the first embodiment of this invention, if the type is binary data, the message part P is judged as being the preceding transmission part. In a case where data of another type is also set as the part that can be precedingly transmitted or other such case, the condition for judging whether or not the part can be precedingly transmitted may be another judgment condition. If the type of the message part P to be processed is not binary data (if Step 605 results in “No”), the processing of Step 605 is executed on another message part P.

For example, in line 12 of the interface definition of Service2 illustrated in FIG. 5, the type of the message part “image” is “xsd:hexBinary”, which indicates that the type is binary data. Therefore, the message part “image” corresponds to the preceding transmission part.

If the message part P to be processed is binary data (if Step 605 results in “Yes”), the CPU 1401 judges that the message part P to be processed can be precedingly transmitted, and creates a record corresponding to the message part P in the preceding transmission part management table 213.

The CPU 1401 first sets so that a variable V′=V, a message part P′=P, a processing step S=C, and a branch B=null (Step 606).

The CPU 1401 then sets a processing step executed immediately before the processing step set as S within the business process definition 211 (BPEL) to variable S (Step 607).

The CPU 1401 causes the procedure to branch into one of the following branch destinations (a) through (d) based on the kind of the processing step S (Step 608).

If the processing step S corresponds to the start of the business process, and if no processing step exists before the processing step S (if the branch destination is (a)), the CPU 1401 executes the processing on another message part P.

If the processing step S is the service call (<invoke>) or the receiving (<receive>), and if a substitution destination of the received message is V′ (if the branch destination is (b)), the CPU 1401 newly adds a record to the preceding transmission part management table 213 (Step 612).

If the branch destination is (b), in the processing step S, the data substituted into the message part P to be finally the preceding transmission part has been received, and hence the preceding transmission can be performed after a time when the processing step S is brought to an end. Therefore, the processing step S becomes a preceding transmission enabling processing step. Then, in the processing of Step 612, a line containing a preceding transmission part P and a preceding transmission enabling processing step S is added to the preceding transmission part management table 213. Detailed description of the processing of Step 612 is described later.

If the processing step S is the substituting (<assign>), if the variable (<variable>) of the substitution destination (<to>) is V′, and if the message part (<part>) is P′ (if the branch destination is (c)), the CPU 1401 updates the values of the variable V′ and the message part P′ (Step 610).

If the branch destination is (c), in the processing step S, the value of the message part (<part>) of the variable (<variable>) of a substitution source (<from>) is substituted into the message part P′ of the variable V′. Therefore, the variable V′ and the message part P′ are set to be equal to the variable (<variable>) of the substitution source and the message part (<part>) of the substitution source, respectively (Step 610), and by continuing the processing, the preceding transmission enabling processing step can be extracted.

If the processing step S is the branching (<switch>) or the repeating (<while>) (if the branch destination is (d)), the CPU 1401 finds that the service call C is a branched processing. Therefore, if the branch destination is (d), and if the value of the branch B is “null”, the branch B is set to “S” (Step 611). If the branch B has been set, a branch closest to the service call C has been set as the branch B, and therefore no processing is executed in Step 611.

It should be noted that the processing step S satisfies none of the conditions for the branch destinations (a) through (d) (if the branch destination is (e)), the procedure returns to the processing of Step 607, and the judging processing of Step 608 is performed on the second earlier step.

Herein, the processing of Step 612 is described in detail. As described above, the processing of Step 612 is a processing executed if the preceding transmission part P and the preceding transmission enabling processing step S are found (if the branch destination is judged as (b) in Step 608). As an outline of the processing, a record containing the preceding transmission part P and the preceding transmission enabling processing step S is added to the preceding transmission part management table 213. Specifically, a line is added with the BP name 401 set to the name of the business process, the service call 402 set to the service call C, the preceding transmission part 403 set to the message part P, the preceding transmission enabling processing step 404 set to the processing step S, and the branch determining step 405 set to the branch B.

For example, discussion is made of a case where the processing of Steps 604 through 613 is executed with regard to the service call C=Service2, the variable V=sv2Req, and the message part P=image. If the processing step S is the receiving (<receive> in line 12 of the business process definition of FIG. 4), and if the variable V′=bpReq, the processing of Step 612 is executed. In other words, data substituted into the message part “image” of the variable sv2Req that stores the message transmitted to Service2 is received in the receiving (<receive>) processing step, and stored into the variable bpReq. Therefore, at a time when the receiving (<receive>) processing step is brought to an end, the message part “image” of the transmission message turns out to be able to be precedingly transmitted to Service2. Therefore, a record 411 with the service call 402 set to Service2, the preceding transmission part 403 set to “image”, and the preceding transmission enabling processing step 404 set to “RECEIVE” is added to the preceding transmission part management table 213 illustrated in FIG. 6A.

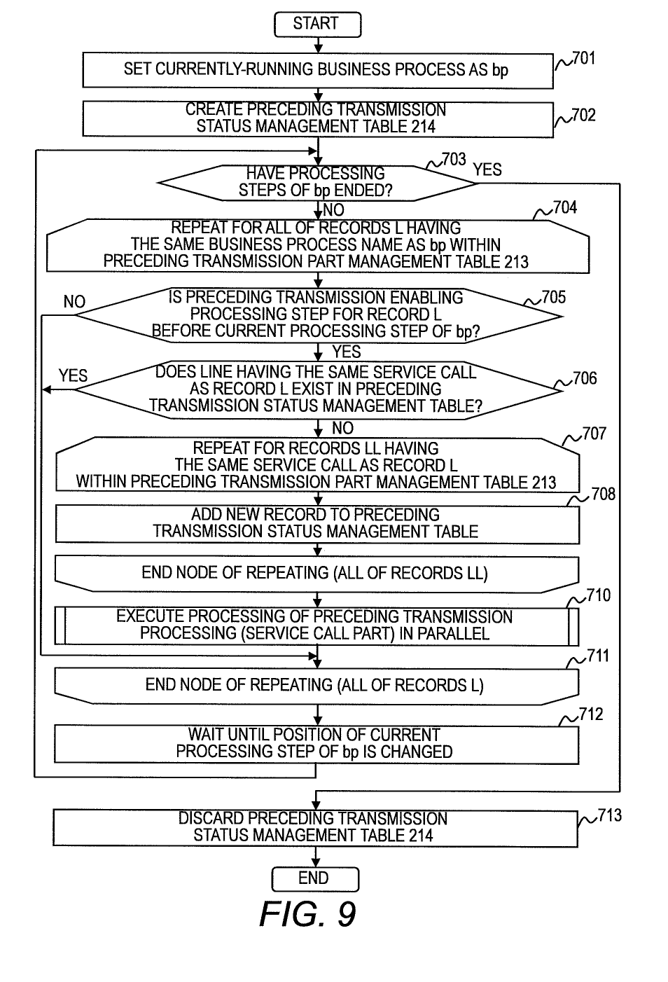

Herein, by using FIGS. 9 through 11, the processing of the preceding transmission module 203 is described. If the business process management module 201 starts the business process, the processing of the preceding transmission module 203 is executed in parallel with the processing of the business process management module 201. Therefore, if a plurality of business processes are executed simultaneously by the preceding transmission module 203, the processings of the preceding transmission module 203 the number of which corresponds to the number of the executed business processes are executed in parallel.

FIG. 9 is a flowchart illustrating a procedure of preceding transmission processing according to the first embodiment of this invention.

The CPU 1401 first sets, as a variable bp, the business process started by the business process management module 201 (Step 701).

The CPU 1401 creates the preceding transmission status management table 214 in the storage device 210 (Step 702). It should be noted that the processings of the preceding transmission module 203 the number of which corresponds to the number of the business processes that are executed in parallel, and hence a plurality of tables may be created as the preceding transmission status management table 214. Hereinafter, the preceding transmission status management table 214 refers to the preceding transmission status management table 214 that is created in the processing of Step 702.

The CPU 1401 judges whether or not all of the processing steps of bp have ended (Step 703). If all of the processing steps of bp have ended (if Step 703 results in “Yes”), the CPU 1401 discards the preceding transmission status management table 214 that is created in the processing of Step 702 (Step 713).

If all of the processing steps of bp have not ended (if Step 703 results in “No”), the CPU 1401 repeatedly perform the processing of Steps 705 through 710 on all of records L having the same business process name 401 set as the BP name 401 as bp within the preceding transmission part management table 213 (Step 704).

The CPU 1401 judges whether or not the preceding transmission enabling processing step 404 for the record L is before the current processing step of bp (Step 705). If the preceding transmission enabling processing step 404 for the record L is not before the current processing of bp (if Step 705 results in “No”), the processing is executed on the next record L.

If the preceding transmission enabling processing step 404 for the record L is before the current processing of bp (if Step 705 results in “Yes”), the CPU 1401 judges whether or not a line having the same service call 421 as the record L exists in the preceding transmission status management table 214 (Step 706). If the line having the same service call 421 as the record L exists in the preceding transmission status management table 214 (if Step 706 results in “Yes”), the processing of Step 707 and the subsequent steps have already been executed, and hence the processing is executed on the next record L.

If the line having the same service call 421 as the record L does not exist in the preceding transmission status management table 214 (if Step 706 results in “No”), the CPU 1401 repeats the processing of Step 708 for all of records LL having the same service call 402 as the record L within the preceding transmission part management table 213 (Step 707).

The CPU 1401 adds a new record to the preceding transmission status management table 214 (Step 708). The service call 402 of the record L is set as the service call 421 of the added record. The preceding transmission part 403 of the record L is set as the preceding transmission part 422. The preceding transmission enabling processing step 404 of the record L is set as the preceding transmission enabling processing step 423. The branch determining step 405 of the record L is set as the branch determining step 424. The value “BEFORE PRECEDING TRANSMISSION” is set as the execution status 425.

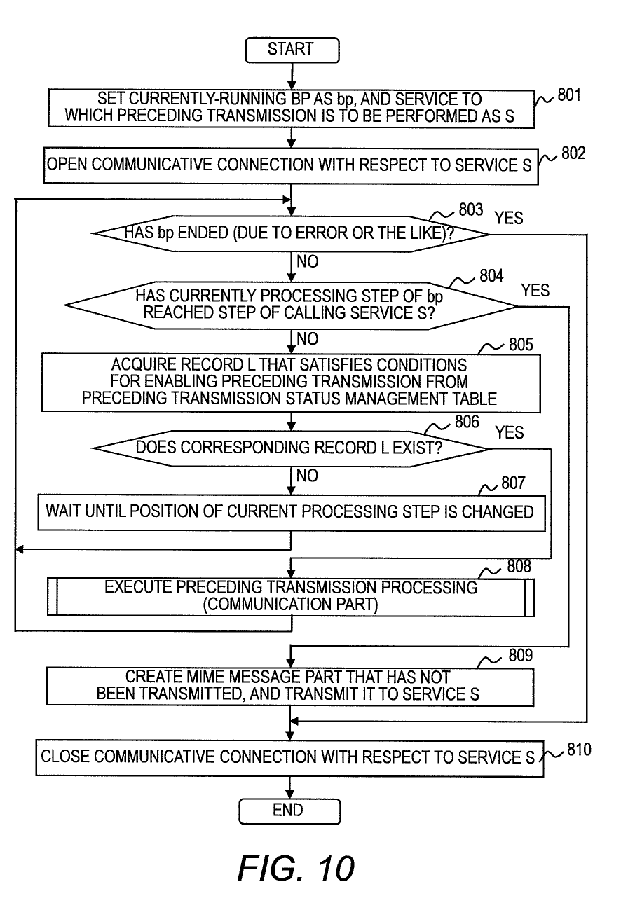

In order to execute the preceding transmission with respect to the service specified in the service call 402 field of the record L, the CPU 1401 executes the preceding transmission processing of a service call part, which is described later by referring to FIG. 10, in parallel (Step 710).

When the processing of Steps 704 through 711 is brought to an end, the CPU 1401 executes the processing of Step 703 after waiting until the current processing step set in bp by the processing of the business process management module 201 shifts to another processing step (Step 712).

FIG. 10 is a flowchart illustrating a procedure of the service call part of the preceding transmission processing according to the first embodiment of this invention.

The CPU 1401 first sets the currently-running business process as the variable bp, and sets the service to which the preceding transmission is to be performed as a variable S (Step 801).

Subsequently, the CPU 1401 opens a communicative connection with respect to the service S (Step 802).

The CPU 1401 judges whether or not the currently-running business process set as the variable bp by the processing of the business process management module 201 has ended due to an error or the like (Step 803). If the business process has ended due to an error or the like (if Step 803 results in “Yes”), the CPU 1401 closes the communicative connection with respect to the service S (Step 810), and brings this processing to an end.

If the currently-running business process set as the variable bp has not ended (if Step 803 results in “No”), the CPU 1401 judges whether or not the business process has reached the service S (Step 804).

If the currently-running business process set as the variable bp has reached the service S (if Step 804 results in “Yes”), the CPU 1401 creates a MIME message part that has not been transmitted, and transmits the MIME message part to the service S (Step 809).

If the currently-running business process set as the variable bp has not reached the service S (if Step 804 results in “No”), the CPU 1401 acquires the record L that satisfies conditions for enabling the preceding transmission from the preceding transmission status management table 214 (Step 805). The record L that satisfies the conditions for enabling the preceding transmission refers to a record that satisfies all of the following conditions A through D.

(Condition A) The service call 421 is equal to the service S.

(Condition B) The preceding transmission enabling processing step 423 is located before the current processing step of the currently-running business process set as the variable bp.

(Condition C) The branch determining step 424 is set to “null”, or the branch determining step 424 is located before the current processing step of bp.

(Condition D) The execution status 425 is set to “BEFORE PRECEDING TRANSMISSION”.

Herein, if the branch determining step 424 is not set to “null”, the service S is included in the branch, but there are some cases where the service S is not called depending on the branch conditions. Condition C is satisfied at a timing when the current processing step of the currently-running business process set as the variable bp becomes after the branch determining step, in other words, at a timing of entering the branch in which the service S is called. Condition C reliably allows the preceding transmission with respect to the service that is called.

As another method, there also exists a method of executing the preceding transmission before the timing of entering the branch in which the service S is called. For example, the preceding transmission is executed with respect to the service S before entering the branch, and in the current processing step of the currently-running business process, the branch determining step is processed. At a timing when it is determined that the procedure is not to enter the branch, the communication for the preceding transmission is discontinued.

The CPU 1401 judges whether or not the corresponding record L exists in the processing of Step 805 (Step 806).

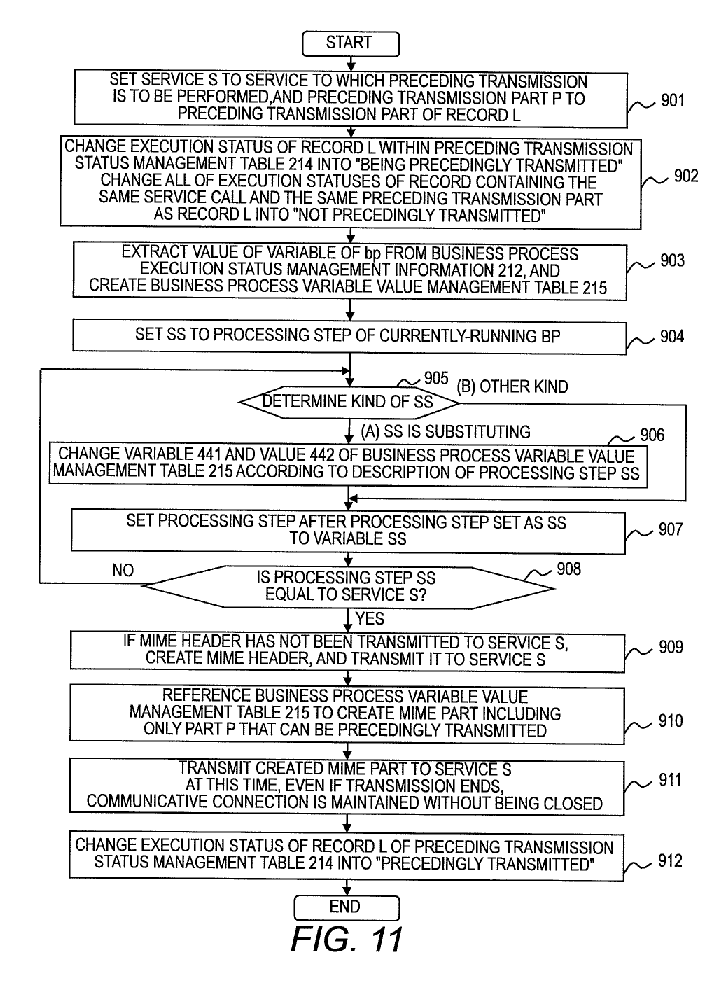

If the corresponding record L exists (if Step 806 results in “Yes”), the CPU 1401 executes a communication part of the preceding transmission processing (Step 808). It should be noted that the communication part of the preceding transmission processing is described later by referring to FIG. 11. If the processing of the communication part of the preceding transmission processing is brought to an end, the procedure returns to the processing of Step 803.

If the corresponding record L does not exist (if Step 806 results in “No”), the CPU 1401 waits until a position of the current processing step is changed by the processing of the business process management module 201 (Step 807), and if the position of the current processing step is changed, the procedure returns to the processing of Step 803.

In the processing of the service call part of the preceding transmission processing, for a reason that a processing time period or a communication time period for the service (other than the service S) called by the currently-running business process is long or other such reason, there are some cases where the processing step of the currently-running business process is slowly changed, forcing long-term waiting in the processing of Step 807. At this time, there is a fear that a timeout occurs due to no data transmission taking place for a long period of time, and that the communicative connection with respect to the service S opened in the processing of Step 802 may be disconnected. Such a case can be handled by, for example, restarting the preceding transmission if a timeout occurs or periodically transmitting dummy data in order to prevent a timeout from occurring.

FIG. 11 is a flowchart illustrating a procedure of the communication part of the preceding transmission processing according to the first embodiment of this invention.

This processing is a processing executed in the processing of Step 808 of the service call part of the preceding transmission processing of FIG. 10.

The CPU 1401 first sets, as the service S, the service to which the preceding transmission is to be performed, and sets the preceding transmission part P to the preceding transmission part of the record L (Step 901).

The CPU 1401 changes the execution status 425 of the record L within the preceding transmission status management table 214 into “BEING PRECEDINGLY TRANSMITTED” (Step 902). Further, if a record containing the same service call 421 and the same preceding transmission part 422 as the record L exists in the preceding transmission status management table 214, the CPU 1401 changes all of the execution statuses 425 of the corresponding record into “NOT PRECEDINGLY TRANSMITTED”. The processing of changing the execution status 425 into “NOT PRECEDINGLY TRANSMITTED” is, for example, a processing for handling a case where there exist a plurality of preceding transmission enabling processing steps such as a case where the preceding transmission enabling processing step corresponding to a given preceding transmission part exists within the branch.

The CPU 1401 acquires a variable used in bp from the business process execution status management information 212, and creates the business process variable value management table 215 (Step 903). The variable 441 serves as all of variables used in the business process set as bp, and as the value 442, a value corresponding to the variable 441 is set.

The CPU 1401 sets, as a variable SS, the processing step of the currently-running business process (Step 904).

The CPU 1401 causes the procedure to branch into one of the following branch destinations (a) and (b) based on the kind of the processing step SS (Step 905).

If the processing step set as SS is the substituting (<assign>) (if the branch destination is (a)), the CPU 1401 changes the variable 441 and the value 442 of the business process variable value management table 215 according to the description of the processing step SS (Step 906). Herein, if the value 442 corresponding to a variable specified in the substitution source (<from>) of the substituting (<assign>) of the processing step SS is “(undefined)”, the value 442 corresponding to a variable specified in the substitution destination (<to >) is set to “(undefined)”.

If the processing step set as SS does not satisfy the condition for the branch destination (a) (if the branch destination is (b)), the CPU 1401 advances to the processing of Step 907 (Step 905).

The CPU 1401 sets the processing step after the processing step set as SS to variable SS (Step 907). At this time, if the processing step SS is the branch (<switch>) or the repeating (<while>), the CPU 1401 references the variable 441 and the value 442 of the business process variable value management table 215 to perform judgment as to the branch conditions or repeating conditions and decide the processing step to be executed next.

The CPU 1401 judges whether or not is processing step SS equal to service S (Step 908). If the processing step SS is not equal to the service S (if Step 908 results in “No”), the CPU 1401 returns to the processing of Step 905.

If the processing step SS is equal to the service S (if Step 908 results in “Yes”), the CPU 1401 executes the processing of Step 909. If a MIME header has not been transmitted to the service S, the CPU 1401 creates a MIME header, and transmits the MIME header to the service S (Step 909).

The CPU 1401 creates a transmission message to be transmitted to the service S based on the variable 441 and the value 442 of the business process variable value management table 215, and extracts only a part P that can be precedingly transmitted from the created transmission message. Then, the CPU 1401 creates a MIME part including the extracted part P that can be precedingly transmitted (Step 910).

The CPU 1401 transmits the MIME part created in the processing of Step 910 to the service S. At this time, even if the transmission ends, the communicative connection is maintained without being closed (Step 911).

Finally, the CPU 1401 changes the execution status of the record L of the preceding transmission status management table 214 into “PRECEDINGLY TRANSMITTED” (Step 912).

Hereinabove, the description is made of the processing for realizing the preceding transmission according to the first embodiment of this invention. Herein, to be more specific in the description, description is made of an example where the first embodiment of this invention is applied to a business process for an online auction listing. This business process is provided to a seller at an auction by a webmaster of an online auction site, and the seller at the auction uses the business process to make item information public on the online auction site, the item information including a name, an image, and item description of an item to be listed at the auction. The webmaster of the online auction site receives auction listing fees charged for a listing of an item on the online auction site from the seller at the auction.

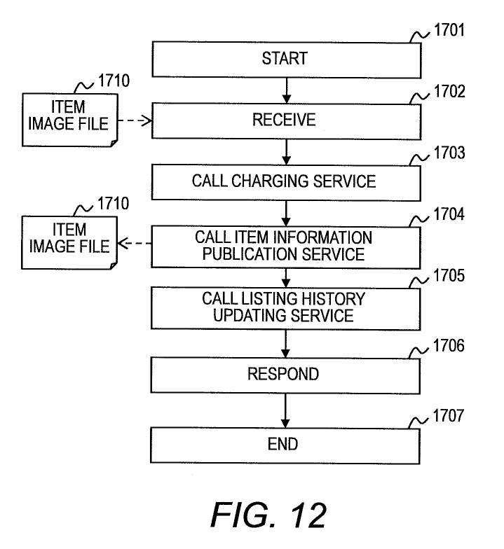

FIG. 12 is a diagram illustrating the business process for an online auction listing task to which the first embodiment of this invention is applied.

Step 1701 “START” indicates the start of the business process. Step 1702 “RECEIVE” represents a processing step of receiving a message from the client. The message received in Step 1702 “RECEIVE” contains an item image file 1710.

Step 1703 “CALL CHARGING SERVICE” represents a processing step of calling a charging service. The charging service executes a processing of charging the seller at the auction for the auction listing fees through credit card settlement or the like.

Step 1704 “CALL ITEM INFORMATION PUBLICATION SERVICE” represents a processing step of calling an item information publication service. The item information publication service executes a processing of making the item information including the name and the image of the item public on the online auction site. A message transmitted in Step 1704 “CALL ITEM INFORMATION PUBLICATION SERVICE” contains the item image file 1710.

Step 1705 “CALL LISTING HISTORY UPDATING SERVICE” represents a processing step of calling a listing history updating service. The listing history updating service is a service that executes a processing of updating a listing history of the auction managed by the webmaster of the online auction site.

Step 1706 “RESPOND” represents a processing step of transmitting a response message to the client. Step 1707 “END” indicates the end of the business process.

A system configuration in a case where the first embodiment of this invention is applied to the business process for the online auction listing is the same as that of FIG. 1. In the system configuration, the business process definition 211 contains the business process for the online auction listing task, and the services 301, 311, and 321 correspond to the charging service, the item information publication service, and the listing history updating service, respectively.

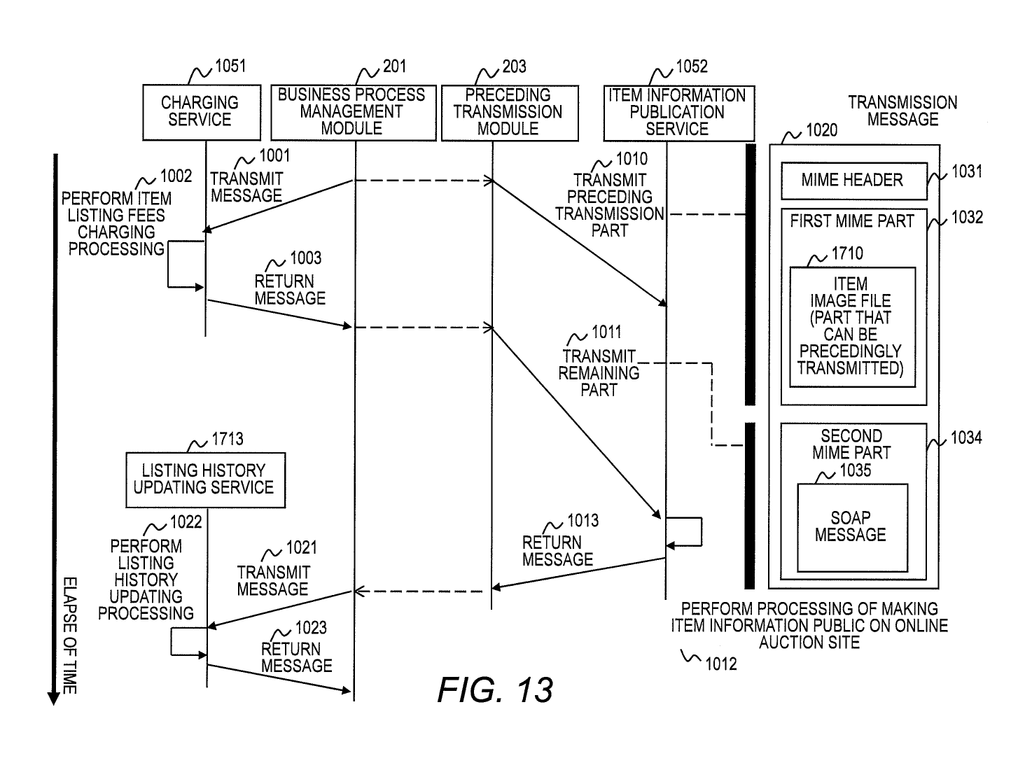

FIG. 13 is a diagram illustrating a flow of a processing in the case where the first embodiment of this invention is applied to the online auction listing task.

FIG. 13 uses an arrow to indicate how a message is exchanged between a charging service 1051, the business process management module 201, the preceding transmission module 203, an item information publication service 1052, and a listing history updating service 1053. FIG. 13 further indicates a timing at which the message is exchanged therebetween by a position along a longitudinal axis. It should be noted that a dotted arrow indicates not how the message is exchanged therebetween but a relationship in the order of timings at which the processings are started.

The business process management module 201 executes Step 1001 “TRANSMIT MESSAGE” with respect to the charging service 1051. Then, the business process management module 201 waits until Step 1002 “PERFORM ITEM LISTING FEES CHARGING PROCESSING” is completed, and receives a message in Step 1003 “RETURN MESSAGE”.

In the business process for the online auction listing task, the message part corresponding to the item image file 1710 contained in the transmission message transmitted to the item information publication service 1052 becomes the preceding transmission part. Therefore, in parallel with the processing of the business process management module 201, the preceding transmission module 203 executes Step 1010 “TRANSMIT PRECEDING TRANSMISSION PART” with respect to the item information publication service 1052, and executes the preceding transmission of the message part including the item image file 1710. Then, after the business process management module 201 receives the message in Step 1003 “RETURN MESSAGE”, the preceding transmission module 203 executes Step 1011 “TRANSMIT REMAINING PART”.

Herein, a transmission message 1020 transmitted to the item information publication service 1052 by the preceding transmission module 203 is formed of 3 message parts, namely, a MIME header 1031, a first MIME part 1032, and a second MIME part 1034. The first MIME part 1032 includes the item image file 1710, and the second MIME part 1034 includes a SOAP message 1035.

The item information publication service 1052 restores an original message from the transmission message 1020 received in Step 1010 “TRANSMIT PRECEDING TRANSMISSION PART” and Step 1011 “TRANSMIT REMAINING PART”. Such a method of restoring the message is realized by a conventional technique such as SwA, MTOM, or MIME. In other words, the item information publication service 1052 and the service execution device 310 are implemented by conventional techniques.

The business process management system has an advantage that the business process management system can speedily structure the business process by combining the existing services, and this invention can use the services implemented by conventional techniques without impairing such an advantage.

After that, the item information publication service 1052 executes Step 1012 “PERFORM PROCESSING OF MAKING ITEM INFORMATION PUBLIC ON ONLINE AUCTION SITE”, and executes Step 1013 “RETURN MESSAGE”. Then, the business process management module 201 executes Step 1021 “TRANSMIT MESSAGE” with respect to the listing history updating service 1053. After executing Step 1022 “PERFORM LISTING HISTORY UPDATING PROCESSING”, the listing history updating service 1053 executes Step 1023 “RETURN MESSAGE” with respect to the business process management module 201.

Herein, for comparison between the first embodiment of this invention and a conventional technique, description is made of a flow of the processing of the business process management system according to the conventional technique.

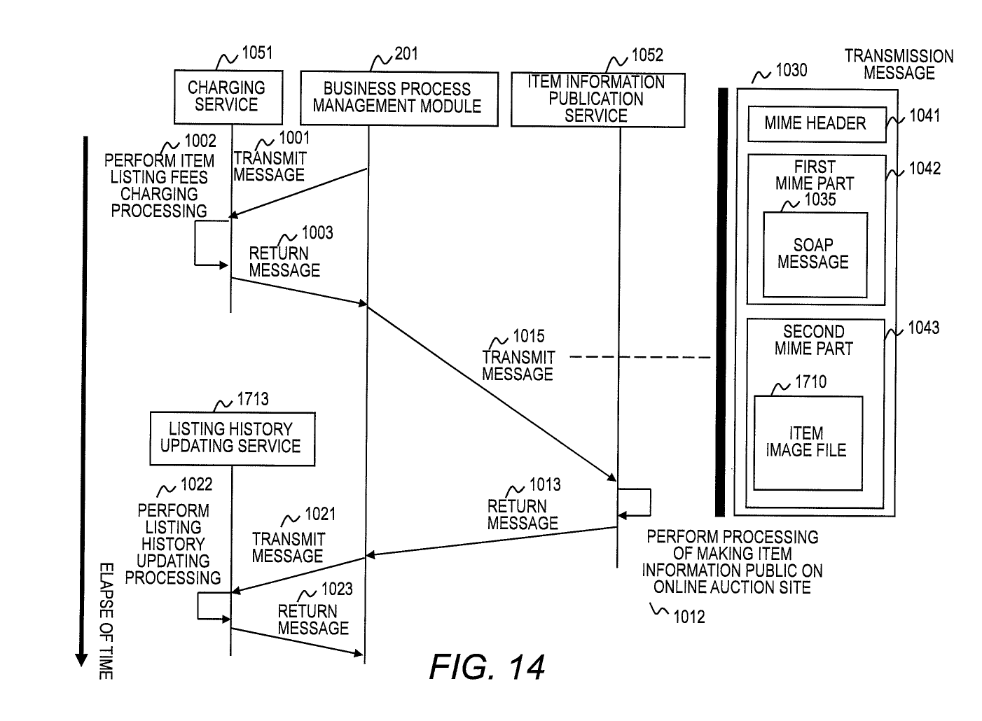

FIG. 14 is a diagram illustrating an example of the flow of the processing in a case where the conventional technique is applied to the online auction listing task according to the first embodiment of this invention.

In comparison with FIG. 13, Step 1010 “TRANSMIT PRECEDING TRANSMISSION PART” does not exist, and in Step 1015 “TRANSMIT MESSAGE”, a transmission message 1030 containing the item image file 1710 is transmitted. Further, a first MIME part 1042 includes the SOAP message 1035, and a second MIME part 1043 includes the item image file 1710. The SOAP message constitutes a leading message part of an entire message, and is often selected as the first MIME part, and hence in FIG. 14, the SOAP message is included in the first MIME part as an example. It should be noted that the SOAP message may be included in the second MIME part in the same manner as the transmission message 1020 of FIG. 13. However, even in this case, the flow of the processing is the same as that of FIG. 14.

In the conventional technique, a time period required for the transmission processing for the transmission message 1030 executed after Step 1003 “RETURN MESSAGE” includes a time period required for the transmission processing for the second MIME part 1043, which is the message part including the item image file 1710. On the other hand, in the first embodiment of this invention, as illustrated in FIG. 13, the transmission processing for the first MIME part 1032, which is the message part including the item image file 1710, is executed in parallel with Step 1001 “TRANSMIT MESSAGE”. Therefore, a time period required for the processing of Step 1011 “TRANSMIT REMAINING PART” executed after Step 1003 “RETURN MESSAGE” does not include a time period required for the transmission processing for the first MIME part 1032, which is the message part including the item image file 1710. Therefore, according to the first embodiment of this invention, compared to the conventional technique, it is possible to reduce a time period required for the entire business process by the time period required for the transmission processing for the message part including the item image file 1710.

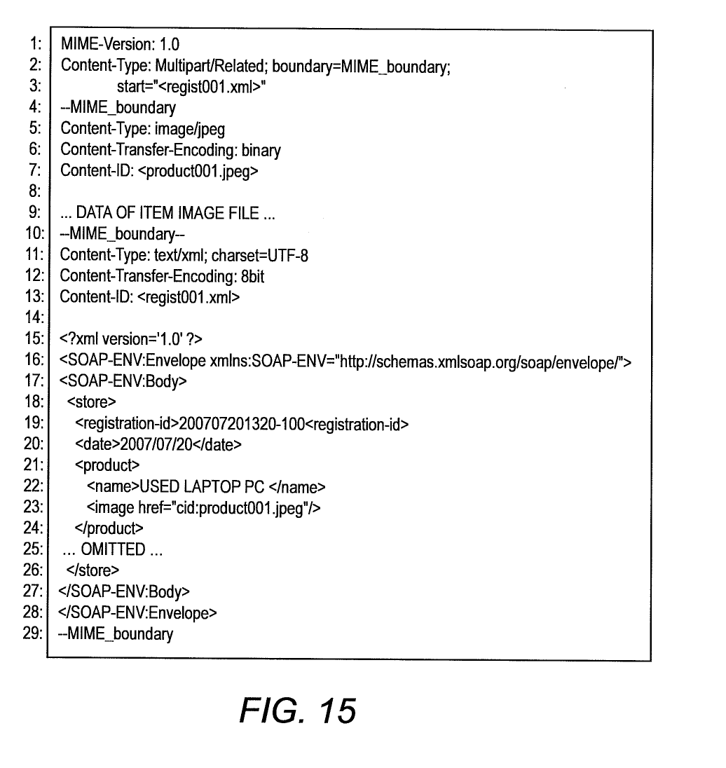

FIG. 15 is a diagram illustrating an example of the message transmitted to the item information publication service 1052 according to the first embodiment of this invention.

In the message transmitted to the item information publication service 1052, lines 1 through 3 correspond to the MIME header 1031, lines 4 through 9 correspond to the first MIME part 1032, and lines 10 through 29 correspond to the second MIME part 1034.

Line 3 of FIG. 15 indicates that the MIME part assigned the identifier “<regist001.xml>” becomes a start position of the leading message part of the entire message. Line 13 indicates that the identifier “<regist001.xml>” is assigned to the MIME part in lines 10 through 29. Line 23 indicates that contents of the element “<image>” is the contents of the MIME part assigned the identifier “product001.jpeg”. Line 7 indicates that the identifier “product001.jpeg” is assigned to the MIME part in lines 4 through 9.

According to the first embodiment of this invention, in parallel with the execution of the processing of Step 1001 “TRANSMIT MESSAGE” by the business process management module 201 or other such processing, Step 1010 “TRANSMIT PRECEDING TRANSMISSION PART” is executed by the preceding transmission module 203. Therefore, it becomes possible to reduce the time period required for the entire business process by a time period required for communicating the message part that is previously transmitted in Step 1010 “TRANSMIT PRECEDING TRANSMISSION PART”.

### Second Embodiment

In the first embodiment of this invention, the preceding transmission part finding module 202 extracts the part that can be precedingly transmitted, while in a second embodiment of this invention, the part that can be precedingly transmitted is previously extracted by the user or the like, and the preceding transmission part management table 213 is created.

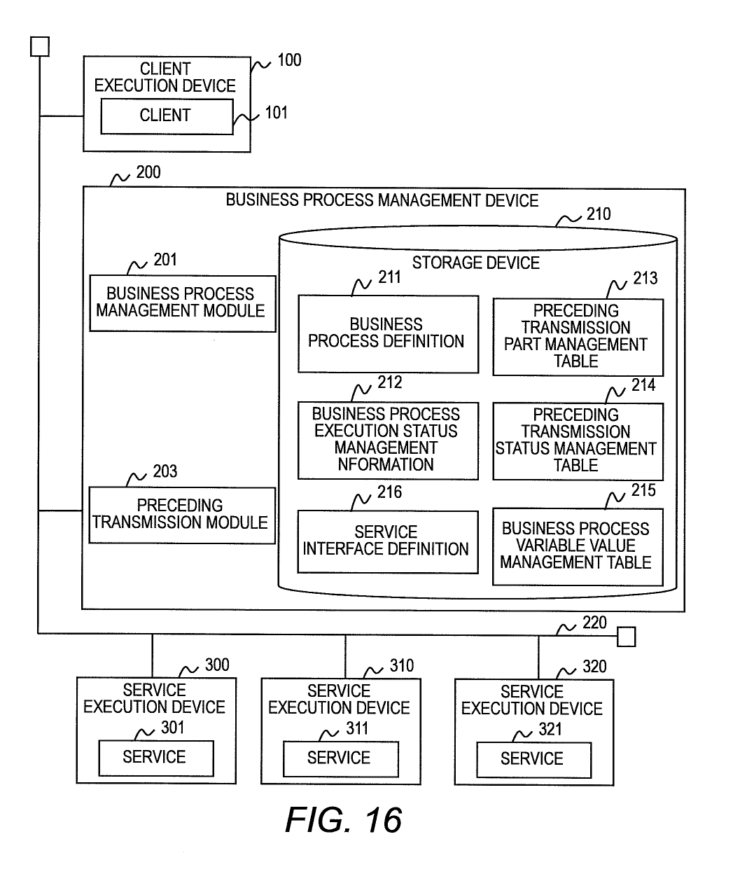

FIG. 16 is a system configuration diagram of a business process management system according to the second embodiment of this invention.

The second embodiment of this invention is configured by excluding the preceding transmission part finding module 202 from the system configuration of the first embodiment of this invention.

In the second embodiment of this invention, an administrator of the business process management system creates the preceding transmission part management table 213. This allows the administrator to perform fine adjustment by adjusting the preceding transmission enabling processing step 423 in order to facilitate prevention of the occurrence of a timeout during communications performed by the preceding transmission module 203, or by restricting the service call 421 for which the preceding transmission is executed in order to improve the communication efficiency.

### Third Embodiment

In the first embodiment of this invention, the preceding transmission is always executed if there exists a part that can be precedingly transmitted, while in a third embodiment of this invention, the preceding transmission of the preceding transmission part is executed only if a predetermined condition is satisfied.

The third embodiment of this invention has the same system configuration as that of the first embodiment of this invention illustrated in FIG. 1, except that there is a partial difference in the procedure of the processing of the preceding transmission module 203. Specifically, the communication part of the preceding transmission processing is different, and the preceding transmission processing is executed only if a predetermined condition is satisfied.

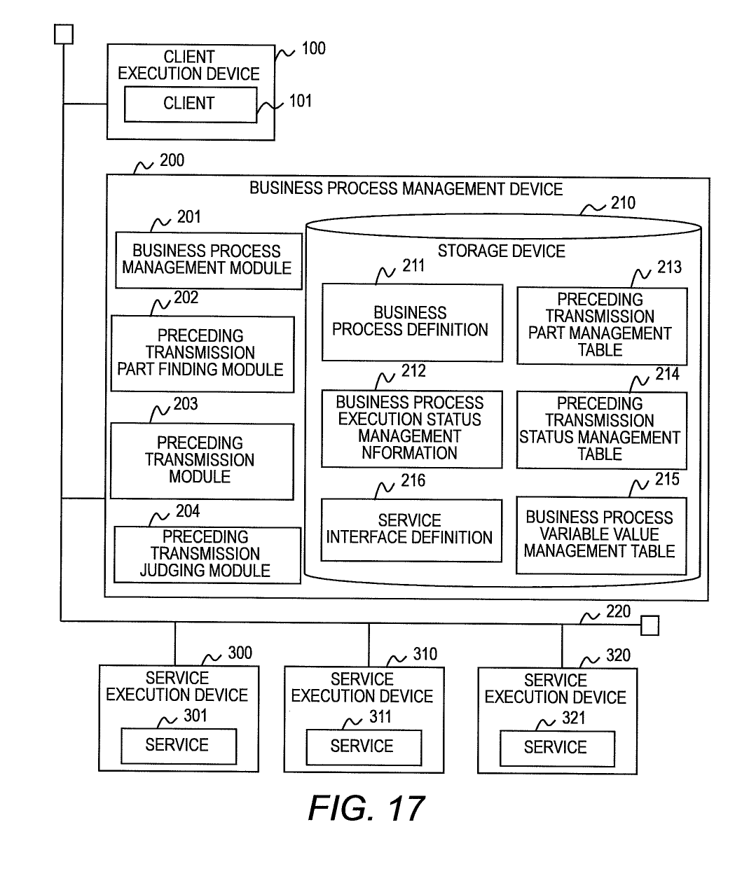

FIG. 17 is a system configuration diagram of a business process management system according to the third embodiment of this invention.

The third embodiment of this invention is configured by additionally providing the business process management device 200 of the system configuration according to the first embodiment of this invention with a preceding transmission judging module 204 for judging whether or not the preceding transmission is to be executed.

The preceding transmission judging module 204 judges whether or not the preceding transmission is to be executed. For example, the preceding transmission judging module 204 calculates a data size of the preceding transmission part, and judges whether or not the preceding transmission is to be executed based on whether or not a predetermined threshold value is exceeded. Further, a function of measuring a system load imposed on the business process management device 200 and a network load imposed between the business process management device 200 and the service execution device may be provided to thereby compare measurement results and predetermined threshold values and judge whether or not the preceding transmission is to be executed.

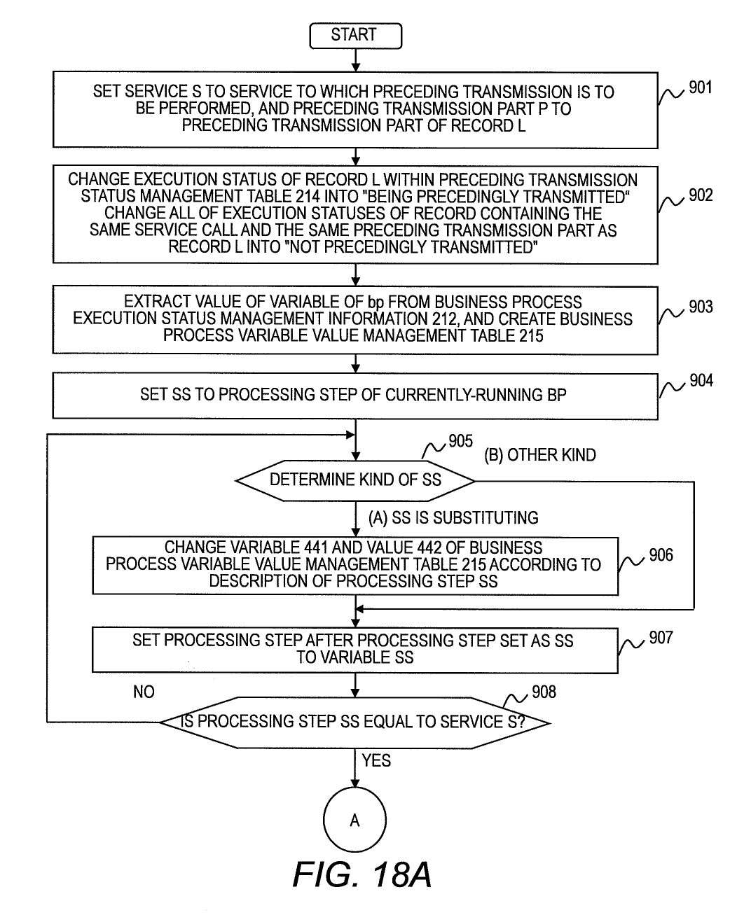

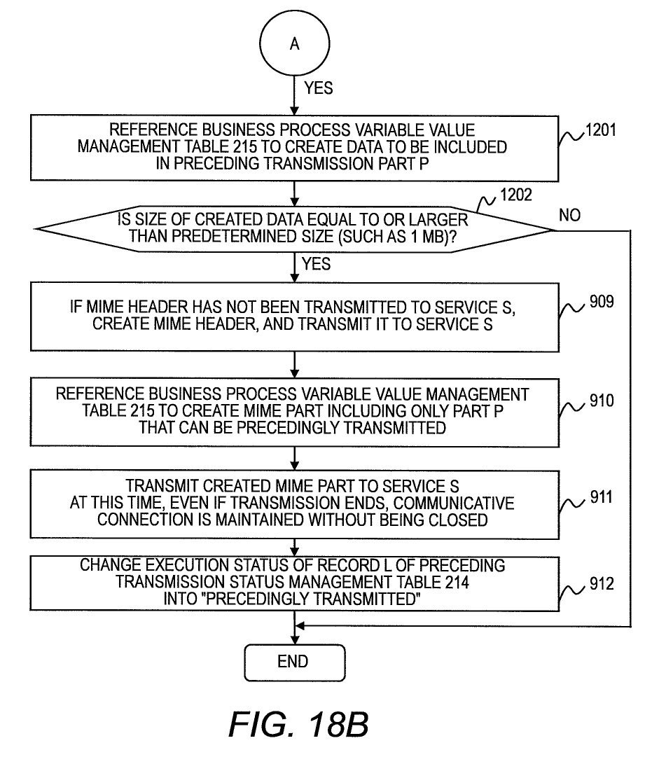

FIG. 18A and FIG. 18B are flowcharts illustrating a procedure of the communication part of the preceding transmission processing according to the third embodiment of this invention.

In the third embodiment of this invention, Steps 1201 and 1202 are inserted between Steps 908 and 909 of the procedure of the communication part of the preceding transmission processing according to the first embodiment of this invention illustrated in FIG. 11.

If it is judged in Step 908 that the processing step SS is equal to the service S (if Step 908 results in “Yes”), the CPU 1401 creates data included in the preceding transmission part P based on the variable 441 and the value 442 within the business process variable value management table 215 (Step 1201).

The CPU 1401 judges whether or not the size of the data created in the processing of Step 1201 is equal to or larger than a predetermined threshold value (given size, for example, 1 MByte) (Step 1202). If the size of the data created in the processing of Step 1201 is equal to or larger than the given size (if Step 1202 results in “Yes”), the CPU 1401 executes the processing of Step 909 and the subsequent steps in the same manner as in the first embodiment of this invention.

On the other hand, if the size of the data created in the processing of Step 1201 is smaller than the given size (if Step 1202 results in “No”), the CPU 1401 ends the communication part of the preceding transmission processing without executing the processing of Step 909 and the subsequent steps.

It should be noted that a specific numerical value of the given size is set by a developer or the administrator of the business process management system. Further, the value of the given size may be determined by a statistical method. In addition, the value of the given size may be changed in proportion to an average time period required from the preceding transmission enabling processing step 404 through the service call 402.

Further, the condition for executing the preceding transmission by which the judgment is made in the processing of Step 1202 is not restricted to the condition regarding the size of the data. As described above, the preceding transmission may be executed only if the size of the data flowing through the network 220 is lower than a predetermined threshold value in consideration of the network load, or the preceding transmission may be executed only if the number of business processes being executed simultaneously is small in consideration of a load on the business process management device. In addition, statistical data on time periods required for the past communications may be referenced to execute the preceding transmission only on the service large in the average time period required for communications.

According to the third embodiment of this invention, the preceding transmission can be executed efficiently by setting the condition for executing the preceding transmission. For example, the preceding transmission is executed only if the size of the data to be precedingly transmitted is large and if a long time period is required for the communication processing. Further, it is possible to prevent such deterioration in performance that the time period required for the entire business process is increased by often executing the preceding transmission on small-size data to thereby increase the load on the business process management device or increase a network traffic amount.

### Fourth Embodiment

In a fourth embodiment of this invention, the business process management system is provided with a shared database (shared DB). The time period required for the entire business process can be reduced by, for example, storing data to be precedingly transmitted in the shared database.

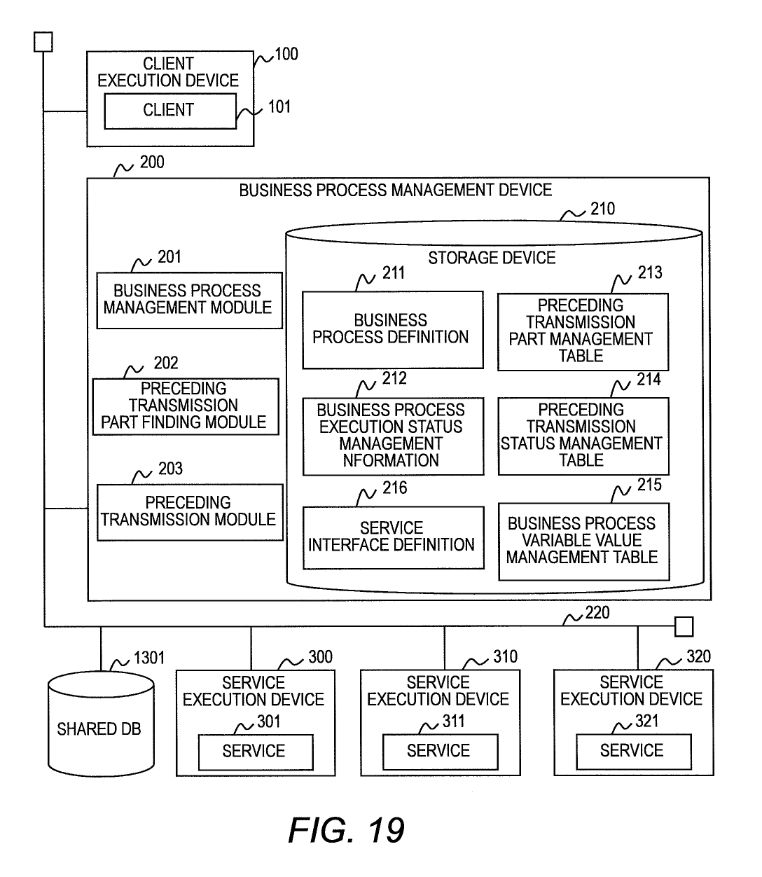

FIG. 19 is a system configuration diagram of a business process management system according to the fourth embodiment of this invention.

The business process management system includes a shared DB 1301 as described above. The shared DB 1301 is connected to the network 220, and is connected therethrough to the business process management device 200 and the service execution device 300.

The business process management device 200 and the service execution device 300 can store data into the shared DB 1301, or reference the data stored in the shared DB 1301.

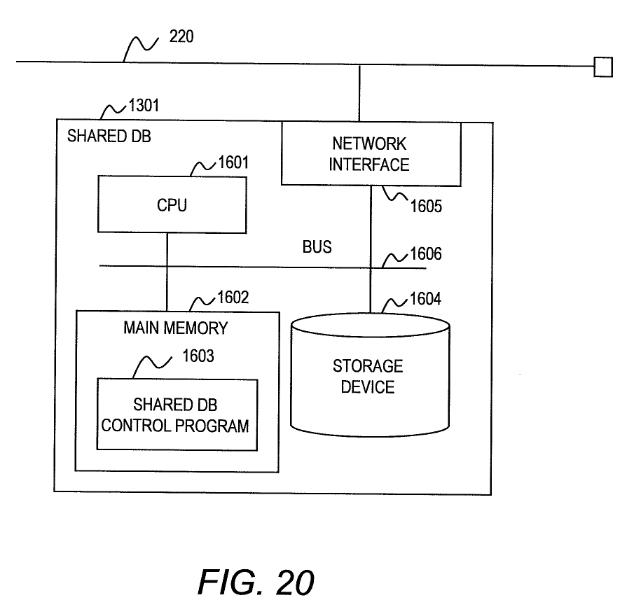

FIG. 20 is a diagram illustrating a configuration of the shared DB 1301 according to the fourth embodiment of this invention.

The shared DB 1301 includes a CPU 1601, a main memory 1602, a storage device 1604, and a network interface 1605. The CPU 1601, the main memory 1602, the storage device 1604, and the network interface 1605 are connected to one another via a bus 1606.

The main memory 1602 stores a shared DB control program 1603 executed by the CPU 1601. Based on a request issued from the business process management device 200, the service execution device 300, or the like, the shared DB control program 1603 executes control for storing data into the storage device 1604 or referencing the data stored in the storage device 1604. The network interface 1605 is connected to the network 220.

In the fourth embodiment of this invention, the data transmitted from the business process management device 200 to the service 301 and the like are not all transmitted to the service as the transmission message, but are partially stored into the shared DB 1301. For example, the business process management device 200 stores the data to be transmitted to the service 301 into the shared DB 1301, and transmits the transmission message to the service 301. Upon reception of the transmission message, the service 301 acquires the data from the shared DB 1301, and executes a predetermined processing.

As in the fourth embodiment of this invention, even in the system configuration including the shared DB, in the same manner as the preceding transmission according to the first embodiment of this invention, data can be transmitted precedingly with respect to the order of service calls specified in the business process definition. The preceding transmission processing according to the fourth embodiment of this invention can be realized by changing a part of the processings performed by the preceding transmission module 203 according to the first embodiment of this invention. Specifically, in the processing of Step 909 of the communication part of the preceding transmission processing performed by the preceding transmission module 203, if the “MIME message part” corresponds to the data stored in the shared DB 1301, not the processing of “transmitting data to the service S” but a processing of “storing data into the shared DB 1301” may be executed.

According to the fourth embodiment of this invention, while the business process management module 201 is waiting for the processing of the service, it is possible to execute the processing of storing data into the shared DB 1301, and hence the time period required for the entire business process can be reduced.

While the present invention has been described in detail and pictorially in the accompanying drawings, the present invention is not limited to such detail but covers various obvious modifications and equivalent arrangements, which fall within the purview of the appended claims.

What is claimed is:

1. A message transmission method for a business process management system comprising: a service execution device; and a business process management device connected to the service execution device,
the message transmission method being used for transmitting a message from the business process management device to the service execution device,
the service execution device providing predetermined services based on the message transmitted from the business process management device,
the business process management device comprising: a processor; a storage section that can be accessed by the processor; and an interface connected to the service execution device,
the business process management device being configured to process a task by executing a business process defined by combining the predetermined services,
the business process including: a definition of the message transmitted to the service execution device; and an order of executing processings of calling the predetermined services,
the business process management system including preceding transmission part management information that includes: a preceding transmission part which is one of a part and an entirety of the message that can be divided and transmitted before one of the predetermined services is called; and information for identifying a processing in which contents of the preceding transmission part can be determined
the message transmission method comprising the steps of:
judging whether or not the processing in which the contents of the preceding transmission part can be determined is performed, based on the preceding transmission part management information; and
transmitting, after the processing in which the contents of the preceding transmission part can be determined has been executed, before a service to which a message including the preceding transmission part is to be transmitted is called, the preceding transmission part to the service execution device providing the service.

2. The message transmission method according to claim 1, wherein:
the business process includes: declaration of a variable for storing a message; specification of a variable for storing a message transmitted to the service execution device; and specification of a variable for storing a message received from the service execution device;
the business process management system further includes variable management information including a value of the variable for storing the message;
the information for identifying the processing in which the contents of the preceding transmission part can be determined, which is included in the preceding transmission part management information, includes information for identifying a processing in which a value of the variable for storing the message transmitted to the service execution device is determined; and
the message transmission method further comprises the steps of:
updating the variable management information based on the business process and the preceding transmission part management information after the value of the variable for storing the message transmitted to the service execution device is determined; and
transmitting the preceding transmission part to the service execution device providing the service based on the updated variable management information and the preceding transmission part management information.

3. The message transmission method according to claim 1, further comprising the steps of:
identifying the preceding transmission part based on the definition of the message transmitted to the service execution device and the order of executing the processings of calling the predetermined services;
identifying the processing in which the contents of the preceding transmission part can be determined; and
recording the identified preceding transmission part and information for identifying a processing in which contents of the identified preceding transmission part can be determined into the preceding transmission part management information.

4. The message transmission method according to claim 1, wherein:
the business process management system further comprises a shared database for storing one of a part and an entirety of the message transmitted to the predetermined service; and
the message transmission method further comprises the steps of:
transmitting the preceding transmission part to the shared database; and
transmitting, by the shared database, the preceding transmission part to the service execution device providing the predetermined service.

5. The message transmission method according to claim 1, further comprising the step of precedingly transmitting the preceding transmission part to the service execution device in a case where a data size of the preceding transmission part is larger than a predetermined threshold value.

6. The message transmission method according to claim 1, further comprising the step of precedingly transmitting the preceding transmission part to the service execution device in a case where traffic of a path connecting the service execution device and the business process management device is smaller than a predetermined threshold value.

7. The message transmission method according to claim 1, further comprising the step of precedingly transmitting the preceding transmission part to the service execution device in a case where the number of business processes being executed by the business process management device is smaller than a predetermined threshold value.

8. A business process management device, which is connected to a service execution device for providing predetermined services,
the business process management device comprising:
a processor;
a storage section that can be accessed by the processor; and
an interface connected to the service execution device, wherein:
the business process management device is configured to process a task by executing a business process defined by combining the predetermined services;
the storage section stores preceding transmission part management information that includes: a preceding transmission part which is one of a part and an entirety of a message that can be divided and transmitted before one of the predetermined services is called; and information for identifying a processing in which contents of the preceding transmission part can be determined;
the business process includes: a definition of the message transmitted to the service execution device; and an order of executing processings of calling the predetermined services; and
after the processing in which the contents of the preceding transmission part can be determined has been executed according to the preceding transmission part management information, before a service to which a message including the preceding transmission part is to be transmitted is called, the processor transmits the preceding transmission part to the service execution device providing the service.

9. The business process management device according to claim 8, wherein:
the business process includes: declaration of a variable for storing a message; specification of a variable for storing the message transmitted to the service execution device; and specification of a variable for storing a message received from the service execution device;
the storage section further includes variable management information including a value of the variable for storing the message;
the information for identifying the processing in which the contents of the preceding transmission part can be determined, which is included in the preceding transmission part management information, includes information for identifying a processing in which a value of the variable for storing the message transmitted to the service execution device is determined; and
the processor is further configured to:
update the variable management information based on the business process and the preceding transmission part management information after the value of the variable for storing the message transmitted to the service execution device is determined; and
transmit the preceding transmission part to the service execution device providing the service based on the updated variable management information and the preceding transmission part management information.

10. The business process management device according to claim 8, wherein the processor is further configured to:
identify the preceding transmission part based on the definition of the message transmitted to the service execution device and the order of executing the processings of calling the predetermined services;
identify the processing in which the contents of the preceding transmission part can be determined; and
record the identified preceding transmission part and information for identifying a processing in which contents of the identified preceding transmission part can be determined into the preceding transmission part management information.

11. The business process management device according to claim 8, wherein the processor is further configured to precedingly transmit the preceding transmission part to the service execution device in a case where a data size of the preceding transmission part is larger than a predetermined threshold value.

12. The business process management device according to claim 8, wherein the processor is further configured to precedingly transmit the preceding transmission part to the service execution device in a case where traffic of a path connecting the service execution device and the business process management device is smaller than a predetermined threshold value.

13. The business process management device according to claim 8, wherein the processor is further configured to precedingly transmit the preceding transmission part to the service execution device in a case where the number of business processes being executed by the business process management device is smaller than a predetermined threshold value.

14. A storage medium recorded with a message transmission program, which is executed by a business process management device that is connected to a service execution device for providing predetermined services and configured to process a task by executing a business process defined by combining the predetermined services,
the business process management device including preceding transmission part management information that includes: a preceding transmission part which is one of a part and an entirety of a message that can be divided and transmitted before one of the predetermined services is called; and information for identifying a processing in which contents of the preceding transmission part can be determined,
the business process including: a definition of the message transmitted to the service execution device; and an order of executing processings of calling the predetermined services,
the message transmission program controlling the business process management device to execute the procedures of:
judging whether or not the processing in which the contents of the preceding transmission part can be determined is performed, based on the preceding transmission part management information; and
transmitting, after the processing in which the contents of the preceding transmission part can be determined has been executed, before a service to which a message including the preceding transmission part is to be transmitted is called, the preceding transmission part to the service execution device providing the service.

15. The storage medium according to claim 14, wherein:
the business process includes: declaration of a variable for storing a message; specification of a variable for storing the message transmitted to the service execution device; and specification of a variable for storing a message received from the service execution device;
the business process management device further includes variable management information including a value of the variable for storing the message;
the information for identifying the processing in which the contents of the preceding transmission part can be determined, which is included in the preceding transmission part management information, includes information for identifying a processing in which a value of the variable for storing the message transmitted to the service execution device is determined; and
the message transmission program further controls the business process management device to execute the procedures of:
updating the variable management information based on the business process and the preceding transmission part management information after the value of the variable for storing the message transmitted to the service execution device is determined; and
transmitting the preceding transmission part to the service execution device providing the service based on the updated variable management information and the preceding transmission part management information.

16. The storage medium according to claim 14, further comprising the procedures of:
identifying the preceding transmission part based on the definition of the message transmitted to the service execution device and the order of executing the processings of calling the predetermined services;
identifying the processing in which the contents of the preceding transmission part can be determined; and
recording the identified preceding transmission part and information for identifying a processing in which contents of the identified preceding transmission part can be determined into the preceding transmission part management information.

17. The storage medium according to claim 14, further comprising the procedure of precedingly transmitting the preceding transmission part to the service execution device in a case where a data size of the preceding transmission part is larger than a predetermined threshold value.

18. The storage medium according to claim 14, further comprising the procedure of precedingly transmitting the preceding transmission part to the service execution device in a case where traffic of a path connecting the service execution device and the business process management device is smaller than a predetermined threshold value.

19. The storage medium according to claim 14, further comprising the procedure of precedingly transmitting the preceding transmission part to the service execution device in a case where the number of business processes being executed by the business process management device is smaller than a predetermined threshold value.
